(19) United States
(12) Patent Application Publication
(10) Pub. No.: US 2026/0009715 A1
(43) Pub. Date: Jan. 8, 2026

(54) METHOD FOR FLOW CYTOMETRY QUALITY SCORES AND SYSTEMS FOR SAME

(71) Applicant: Becton, Dickinson and Company, Franklin Lakes, NJ (US)

(72) Inventors: Peter Ludington Mage, San Jose, CA (US); Keegan Owsley, Campbell, CA (US); Wenyu Bai, San Jose, CA (US)

(21) Appl. No.: 19/256,552

(22) Filed: Jul. 1, 2025

Related U.S. Application Data
(60) Provisional application No. 63/667,408, filed on Jul. 3, 2024.

(51) Int. Cl. G01N 15/1429

(52) U.S. Cl. CPC G01N 15/1429

(57) ABSTRACT

Aspects of the present disclosure include methods for identifying measurement uncertainty associated with light detected from a sample. Methods according to certain embodiments include introducing a sample into a flow cytometer, flowing the introduced sample in a flow stream, irradiating the sample in the flow stream with a light source, detecting light from particles in the sample flowing in the flow stream and, identifying measurement uncertainty associated with the detected light. In some embodiments, measurement uncertainty is identified corresponding to individual particles in the sample. In certain embodiments, measurement uncertainty is identified for individual parameters of detected light for particles in the sample. Methods according to some embodiments further comprise generating a quality score for each particle based on the measurement uncertainty for each particle. Systems, integrated circuit devices (e.g., a field programmable gate array) and non-transitory computer readable storage mediums for practicing the subject methods are also provided.

### CROSS-REFERENCE TO RELATED APPLICATION

Pursuant to 35 U.S.C. § 119 (e), this application claims priority to the filing date of U.S. Provisional Patent Application Ser. No. 63/667,408 filed Jul. 3, 2024, the disclosure of which application is incorporated herein by reference in its entirety.

### INTRODUCTION

The characterization of analytes in biological fluids has become an important part of biological research, medical diagnoses and assessments of overall health and wellness of a patient. Detecting analytes in biological fluids, such as human blood or blood derived products, can provide results that may play a role in determining a treatment protocol of a patient having a variety of disease conditions.

Flow cytometry is a technique used to characterize and often times sort biological material, such as cells of a blood sample or particles of interest in another type of biological or chemical sample. A flow cytometer typically includes a sample reservoir for receiving a fluid sample, such as a blood sample, and a sheath reservoir containing a sheath fluid. The flow cytometer transports the particles (including cells) in the fluid sample as a cell stream to a flow cell, while also directing the sheath fluid to the flow cell. To characterize the components of the flow stream, the flow stream is irradiated with light. Variations in the materials in the flow stream, such as morphologies or the presence of fluorescent labels, may cause variations in the observed light and these variations allow for characterization and separation. To characterize the components in the flow stream, light must impinge on the flow stream and be collected. Light sources in flow cytometers can vary and may include one or more broad spectrum lamps, light emitting diodes as well as single wavelength lasers. The light source is aligned with the flow stream and an optical response from the illuminated particles is collected and quantified.

Isolation of biological particles has been achieved by adding a sorting or collection capability to flow cytometers. Particles in a segregated stream, detected as having one or more desired characteristics, are individually isolated from the sample stream by mechanical or electrical removal. A common flow sorting technique utilizes drop sorting in which a fluid stream containing linearly segregated particles is broken into drops. The drops containing particles of interest are electrically charged and deflected into a collection tube by passage through an electric field. Typically, the linearly segregated particles in the stream are characterized as they pass through an observation point situated just below the nozzle tip. Once a particle is identified as meeting one or more desired criteria, the time at which it will reach the drop break-off point and break from the stream in a drop can be predicted. Ideally, a brief charge is applied to the fluid stream just before the drop containing the selected particle breaks from the stream and then grounded immediately after the drop breaks off. The drop to be sorted maintains an electrical charge as it breaks off from the fluid stream, and all other drops are left un-charged.

Flow cytometry is used to measure features of single particles or cells based on optical signals. To effectively identify and/or separate populations of particles or cells based on these measured signals, practitioners must be able to determine whether a measured difference in signal between two particles is due to a true intrinsic difference between those particles or whether the measured difference in signal is due to random measurement error. Ultimately, the presence of measurement error affects the confidence with which a classification decision may be made for a given particle or cell.

Currently, flow cytometry data does not comprise any information about measurement uncertainty at the event-specific or parameter-specific or population-specific levels. Practitioners are required to manually measure, calculate, or estimate sources of measurement uncertainty.

### SUMMARY

Thus, the inventors have realized that there is a need for automatically reporting measurement uncertainty and classification uncertainty of flow cytometry data through, for example, quantitative quality scores. In particular, there is a need for improved ability to differentiate true biological variability from measurement error. Embodiments of the present disclosure address this need. Embodiments of the present disclosure address limitations of existing techniques by associating event-specific measurement uncertainties with the event data, for example. In embodiments, methods for estimating event-specific measurement uncertainty are provided. Such improvements of existing techniques may, among other things, improve sort purity and yield.

Aspects of the present disclosure include methods for identifying measurement uncertainty associated with light detected from a sample. Methods according to certain embodiments include introducing a sample into a flow cytometer, flowing the introduced sample in a flow stream, irradiating the sample in the flow stream with a light source, detecting light from particles in the sample flowing in the flow stream and, identifying measurement uncertainty associated with the detected light. In some embodiments, measurement uncertainty is identified corresponding to individual particles in the sample. In certain embodiments, measurement uncertainty is identified for individual parameters of detected light for particles in the sample. Methods according to some embodiments further comprise generating a quality score for each particle based on the measurement uncertainty for each particle. Systems, integrated circuit devices (e.g., a field programmable gate array) and non-transitory computer readable storage mediums for practicing the subject methods are also provided.

### BRIEF DESCRIPTION OF THE FIGURES

The disclosure may be best understood from the following detailed description when read in conjunction with the accompanying drawings. Included in the drawings are the following figures:

FIG. 1A shows exemplary results 100 of flow cytometric measurements of events with associated biological and measurement uncertainties. FIG. 1B shows exemplary hierarchical gates applied to events of a sample. FIG. 1C shows techniques for addressing measurement uncertainty according to the prior art. FIG. 1D shows a technique for identifying measurement uncertainty on per-parameter, per-event per-gate or per-sample or per-recording basis, according to an embodiment. FIG. 1E shows an exemplary processes for estimating measurement uncertainty, according to a “GLS unmixing approach.” FIG. 1F shows measurement data storage according to prior art. FIG. 1G shows techniques for recording measurement data along with measurement uncertainty data according to embodiments. FIG. 1H shows a flow diagram for identifying measurement uncertainty and classification uncertainty of flow cytometry data according to an embodiment.

FIG. 2 presents a flow cytometric system according to certain embodiments.

FIG. 3 depicts an image-enabled particle sorter according to certain embodiments.

FIG. 4 depicts a functional block diagram of a particle analysis system according to certain embodiments.

FIG. 5 depicts a depicts a functional block diagram for one example of a control system according to certain embodiments.

FIG. 6A-6B depict schematic drawings of a particle sorter system according to certain embodiments.

FIG. 7 depicts aspects of a computer-controlled system according to certain embodiments.

### DETAILED DESCRIPTION

Aspects of the present disclosure include methods for identifying measurement uncertainty associated with light detected from a sample. Methods according to certain embodiments include introducing a sample into a flow cytometer, flowing the introduced sample in a flow stream, irradiating the sample in the flow stream with a light source, detecting light from particles in the sample flowing in the flow stream and, identifying measurement uncertainty associated with the detected light. In some embodiments, measurement uncertainty is identified corresponding to individual particles in the sample. In certain embodiments, measurement uncertainty is identified for individual parameters of detected light for particles in the sample. Methods according to some embodiments further comprise generating a quality score for each particle based on the measurement uncertainty for each particle. Systems, integrated circuit devices (e.g., a field programmable gate array) and non-transitory computer readable storage mediums for practicing the subject methods are also provided.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order which is logically possible.

While the system and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

As summarized above, the present disclosure provides methods for identifying measurement uncertainty associated with light detected from a sample. In further describing embodiments of the disclosure, methods for identifying measurement uncertainty associated with light detected from a sample, including identifying measurement uncertainty corresponding to individual particles in the sample as well as identifying measurement uncertainty for individual parameters of detected light for particles in the sample as well as generating a quality score for each particle based on the measurement uncertainty for each particle. Next, systems, integrated circuit devices and non-transitory computer readable storage mediums, in each case programmed to practice the subject methods, are described.

### BACKGROUND

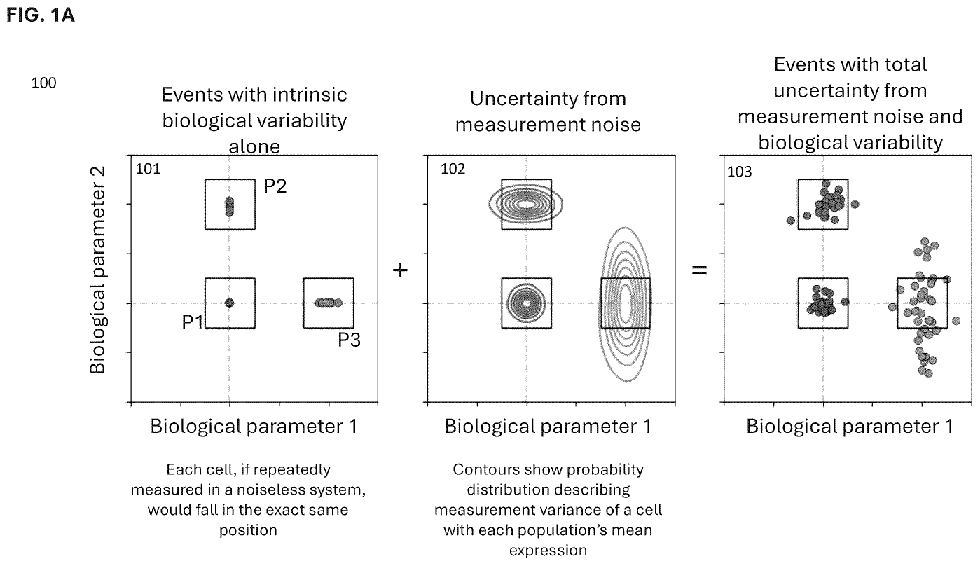

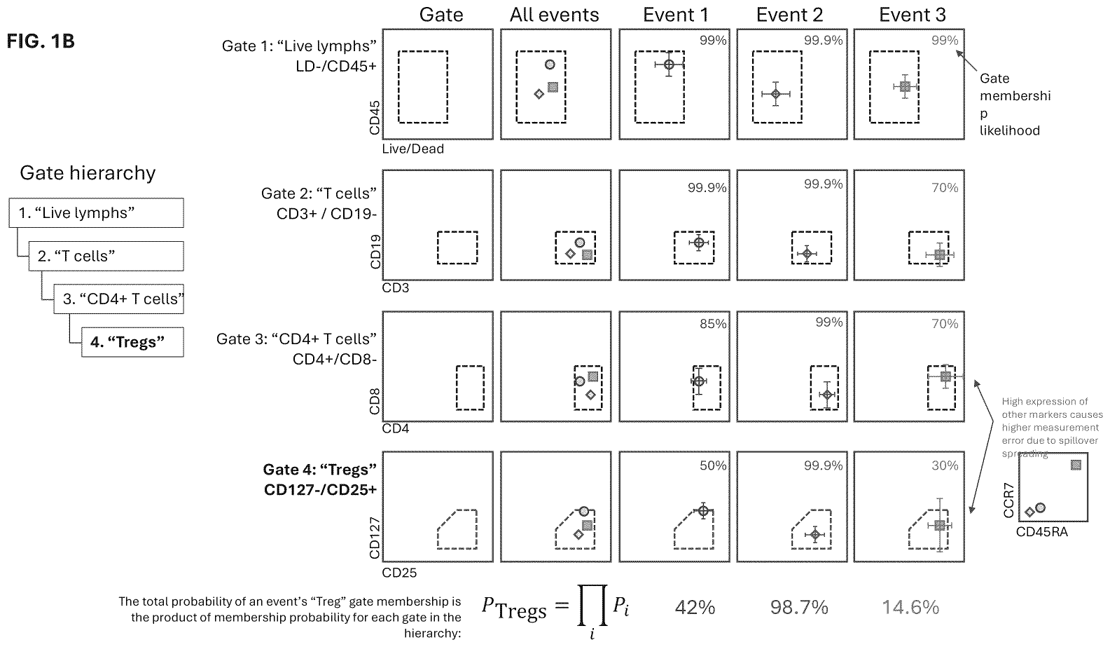

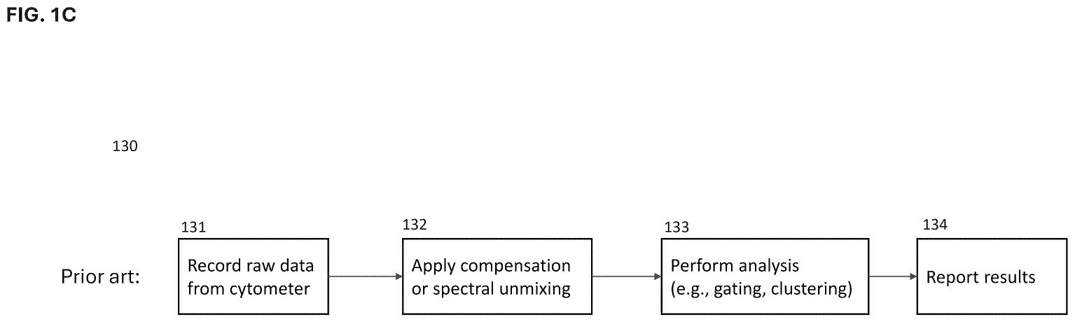

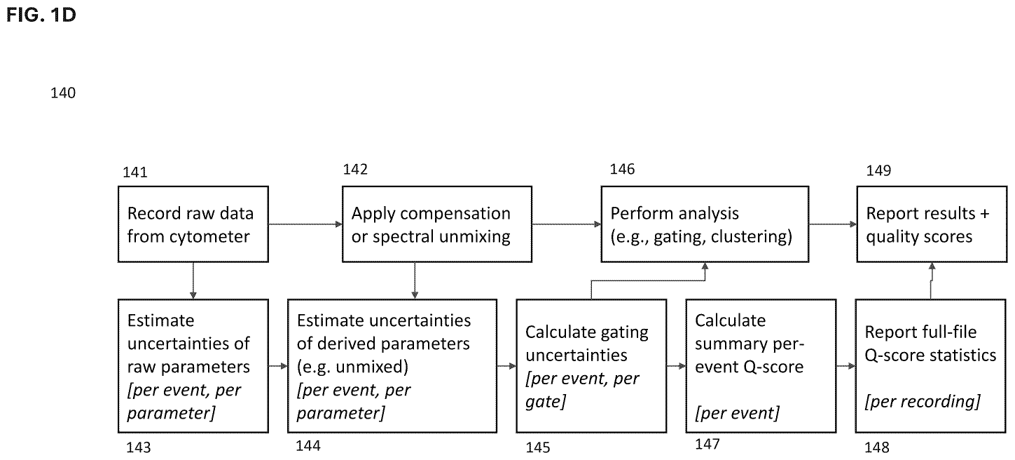

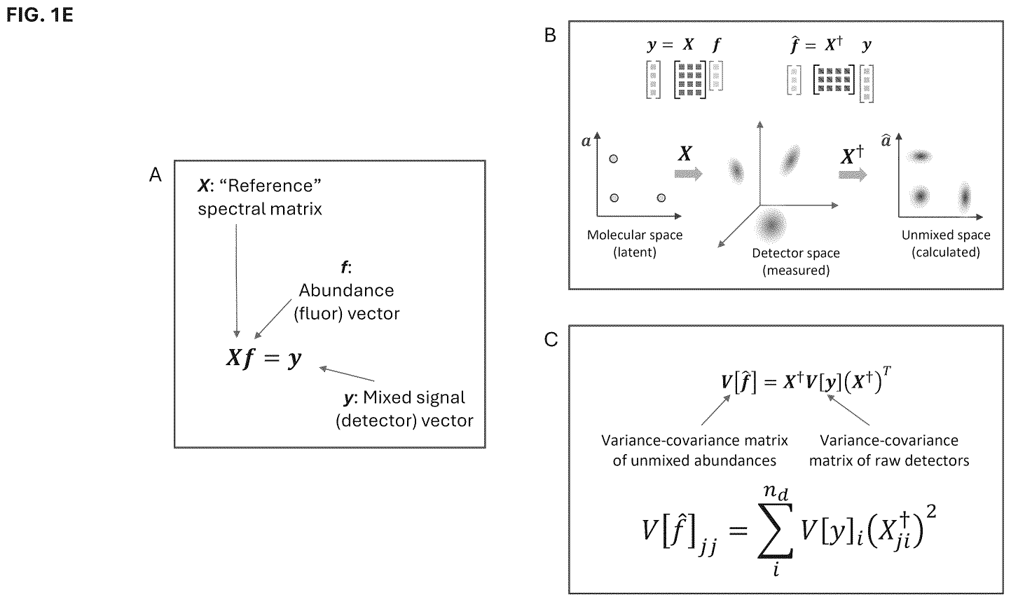

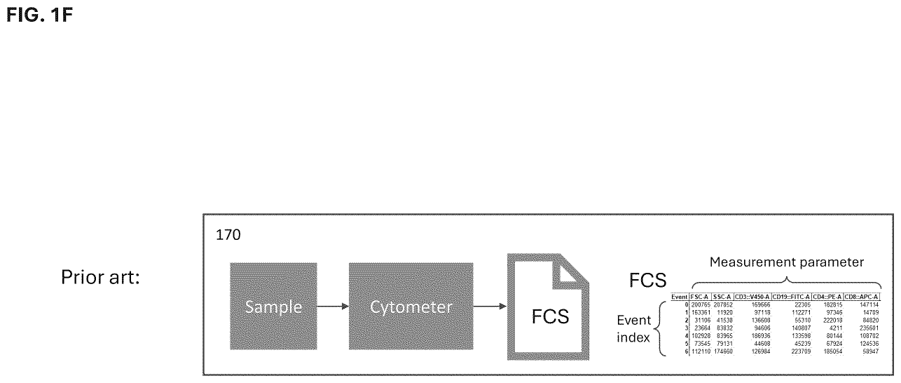

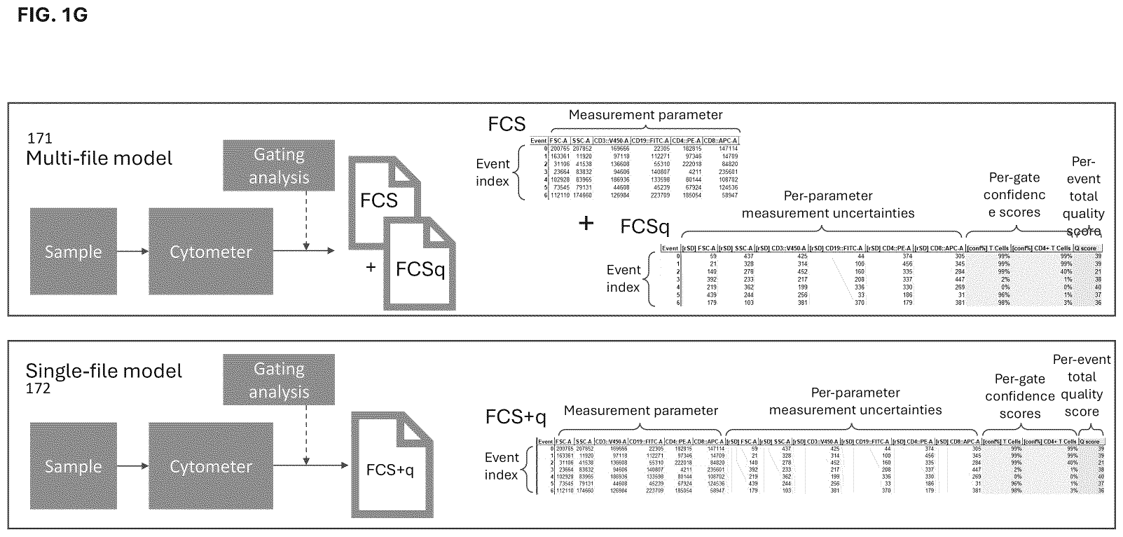

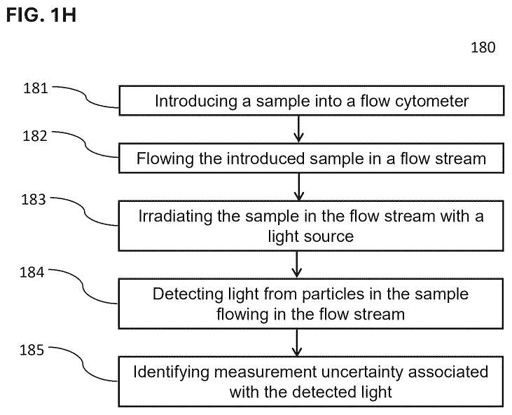

As discussed herein, flow cytometry is used to measure features of single particles (also referred to as microparticles) or cells based on optical signals (i.e., detected light). A frequent use case of flow cytometry is identifying different cell subpopulations (or cell populations) or particle types based on differences in measured optical signals, such as the quantity of emitted fluorescence from fluorochrome-labeled antibodies in one or more spectral detection bands, or the quantity of elastically-scattered light measured at different angles (e.g., forward scatter and side scatter). To effectively identify and separate populations of cells or particles based on these measured signals, practitioners must be able to determine whether a measured difference in signal between two particles is due to a true intrinsic difference between those particles (e.g., a difference in expression of a biological marker, or a difference in cell size or morphology), or whether the measured difference in signal is due to random measurement error (also called measurement noise, measurement uncertainty, or measurement variability). FIG. 1A depicts exemplary results 100 of flow cytometric measurements of events, illustrating how overall variation in such measurements 103 is comprised of intrinsic biological variability alone 101 combined with uncertainty from measurement noise 102. FIG. 1B shows exemplary hierarchical gates applied to events of a sample. Ultimately, the presence of measurement error affects the confidence with which a classification decision (i.e., gating) may be made for a given microparticle, as illustrated in FIG. 1B.

Measurement error is unavoidable in flow cytometry and can arise from multiple sources including, for example, electronic noise (e.g., Johnson-Nyquist noise), digitization error, photonic shot noise, or random variations in optical excitation and collection efficiency arising from random fluctuations in illumination intensity, fluidics, optical alignment, photodetector gain, and other hardware components over the course of an experimental measurement. The magnitude of error arising from each of these sources depends on the specific instrument, sample, and measurement conditions (such as, for example, photodetector gain, flow rate, etc.) used for a given sample. The total uncertainty in a flow cytometry sample (i.e., total uncertainty related to measurements of detected light corresponding to events in a flow cytometry sample) arises from a combination of the above-mentioned measurement uncertainty as well as intrinsic variability in the sample itself, such as, for example, randomly varying degrees of expression of a biological molecule on a single biological cell population of interest, or randomly varying degrees of fluorescence intensity in a synthetic fluorescent bead arising from uncontrollable variation in the manufacturing process.

A significant source of measurement uncertainty in multicolor flow cytometry experiments is so-called “spillover-spreading error.” See Nguyen R, Perfetto S, Mahnke YD, Chattopadhyay P, Roederer M. Quantifying spillover spreading for comparing instrument performance and aiding in multicolor panel design. Cytometry A. 2013 March; 83 (3): 306-15. doi: 10.1002/cyto.a.22251. Epub 2013 Feb. 6. PMID: 23389989; PMCID: PMC3678531. This manifests as increased variance in spectrally unmixed or compensated measurement parameters—typically the parameters of interest in biological analysis—as a result of photonic shot noise originating from fluorescence emission from one or more fluorophores that are co-expressed with another fluorophore of interest.

The ability to differentiate true biological variability from measurement error is a significant limiting factor for sensitivity and resolving power in flow cytometry assays. Embodiments of the present invention address such limitations by providing novel and inventive techniques for distinguishing and accounting for measurement error or measurement uncertainty, including in the context of flow cytometric experiments.

In certain existing techniques, measurement error in flow cytometry may quantified in one of two ways: (i) first, by using controlled reference samples and protocols to measure different sources of measurement noise a priori, or (ii) second, by applying statistical analyses to measured data a posteriori.

In the first uncertainty measurement approach according to existing techniques (item (i) above), the measurement error of a given instrument is measured using specific types of controlled reference samples. For example, calibration beads with low intrinsic variability and well-characterized intensities may be used to measure the robust standard deviation (rSD) and robust coefficient of variation (rCV) of a given optical measurement parameter. More complex protocols can enable the measurement of specific noise sources under controlled conditions. For example, a technique that may be employed involves the use of electronic event triggering in the absence of particles to measure signal-independent background noise (“B”) under varying system conditions, such as the presence or absence of constant optical noise arising from excitation light sources. In another example, particle-free signal sources such as light-emitting diodes (LEDs) may be used to characterize measurement error arising exclusively from constant background and from photon counting error, in the absence of particle-dependent error sources such as intrinsic intensity variation and fluidic/optical fluctuations. Finally, in another example, representative biological samples, such as single-stain controls or fluorescence-minus-one (FMO) controls, can be used to infer the degree of total uncertainty that would be present in a fully-stained sample of interest in a multicolor flow cytometry panel. An advantage or benefit of this first uncertainty measurement approach (i.e., techniques under item (i) above) is that it allows measurement of specific sources of measurement variance isolated from biological and sample-dependent sources of variation. However, a disadvantage or downside of this first measurement approach (i.e., techniques under item (i) above) is that measurement uncertainty is not measured directly in the sample of interest under that sample's measurement conditions, and, further, measurement uncertainty cannot be associated with specific single cells or particles in a given dataset. Moreover, to apply statistical insights from these separate uncertainty measurements to a given sample of interest, the measurements must be manually associated with each other, and some empirical corrections must be made to account for differences in measurement conditions between the calibration sample and the sample of interest.

In the second uncertainty measurement approach according to existing techniques (item (ii) above), statistical techniques are applied to data from a sample of interest after such data has been acquired. A typical workflow would be to identify a subpopulation of interest via gating on some set of measurement parameters, and then apply appropriate statistical metrics such as robust standard deviation (rSD) or robust coefficient of variation (rCV) to the events in that subpopulation. Additional metrics such as stain index or separation index may be used to define the statistical degree of separation between two subpopulations with respect to a given measurement parameter. Statistical confidence may be gained by performing technical replicates, e.g., measuring the same sample multiple times. An advantage of this second uncertainty measurement approach (item (ii) above) is that it describes uncertainty for the specific sample and population of interest, under the exact measurement conditions used. An important disadvantage of this approach (item (ii) above), however, is that it cannot be used to discriminate between technical measurement uncertainty arising from the measurement process and biological variability arising from the intrinsic biological properties of the sample itself. Such disadvantage or limitation prevents practitioners from differentiating between measurement noise and biologically meaningful variation.

FIG. 1C illustrates existing a technique for addressing measurement uncertainty according to the prior art. Flow diagram 130, starts at step 131 with recording raw data from a flow cytometer. Upon completing step 131, flow diagram 130 proceeds to step 132. At step 132, spectral unmixing is performed on data acquired by the flow cytometer at step 131. Compensation or spectral unmixing may be performed using any convenient compensation or spectral unmixing technique. Further details regarding spectral unmixing are provided in International Application No. PCT/US2021/026616, published as International Publication No. WO 2021/221884 A1, as well as International Application No. PCT/US2021/046741, published as International Publication No. WO 2022/076088 A1, the disclosures of each of which are herein incorporated by reference. Upon completing step 132, flow diagram 130 proceeds to step 133. At step 133, data analysis is performed of flow cytometric data acquired at step 131. Such analysis may include, for example, applying one or more gating or clustering algorithms. Upon completing step 133, flow diagram 130 proceeds to step 134. At step 134, results, i.e., results of processing the flow cytometric data in steps 132 and 133, are reported. Unlike embodiments of the present invention, flow diagram 130 is not able to identify and report resulting metrics of measurement uncertainty on a per-parameter, per-particle, per-population, and/or per-sample basis.

### Embodiments of the Present Invention

Embodiments of the present invention employ an alternative approach, in which the measurement uncertainty of some or all measurement parameters for each particle in a flow cytometry sample are directly estimated, measured, or predicted, and the resulting measurement uncertainty metrics are associated with the flow cytometry sample data. In embodiments, the resulting metric(s) of measurement uncertainty may be identified or reported or recorded on a per-parameter, per-particle, per-population, and/or per-sample basis, or any combination thereof. FIG. 1D illustrates a technique for identifying measurement uncertainty on per-parameter, per-event per-gate or per-sample or per-recording basis, according to an embodiment. Flow diagram 140 starts at step 141 where raw flow cytometric data is recorded. Subsequent processing occurs in subsequent steps of flow diagram 140, where measurement data is addressed in steps 141, 142, 146 and 149, and measurement uncertainty associated with such measurement data is addressed at steps 143, 144, 145, 147 and 148. Such raw cytometric data is further processed at steps 143 and step 142. At step 142, compensation or spectral unmixing may be applied to the raw cytometric data. Such compensation or spectral unmixing results in computing or estimating derived parameters. At step 143, measurement uncertainty is estimated on a per-parameter or per-event basis based on the raw parameter data acquired at step 141. At step 144, measurement uncertainty is estimated based on the derived parameters on a per-parameter or per-event basis. At step 145, gating uncertainties are estimating on a per-event or per-parameter basis. At step 147, a summary of measurement uncertainty is calculated, in this case comprising a per-event Q-score, as discussed herein. At step 147, such results are obtained on a per-recording or per-sample basis. At step 146, analysis, such as applying a gating or clustering algorithm is performed, on the flow cytometric data, in this case on events using the derived parameters (i.e., unmixed data). At step 148, a full file of Q-score statistics are reported, e.g., recorded or displayed. At step 149, full results of analyzed flow cytometric data, including quality scores, such as, for example, Q-scores, are reported, e.g., recorded or displayed. In embodiments, the associated measurement uncertainty data, such as, for example, that calculating in steps 144, 145 and 147 of flow diagram 140, may be used to provide more precise data analysis, to increase statistical confidence in analysis results, to achieve higher-fidelity unsupervised clustering, and to report overall measurement quality and assay performance, among other things.

Embodiments of the present disclosure may be applied to single-cell analysis modalities beyond flow cytometry. For example, embodiments of the present disclosure may be applied in the context of sequencing-based single-cell proteomics such as CITE-Seq (BD AbSeq).

### Conceptual Similarities in the Context of Next-Generation Sequencing:

Embodiments of the present invention are similar conceptually to the ubiquitous use of Phred quality scores (“Q scores”) in DNA sequencing. A Q score in the context of DNA sequencing is defined as the negative logarithm of the probability that a given base-call is incorrect, reported in logarithmic decibel units (e.g., a Q score of 30 indicates a 1 in 1,000 probability of a base-call error, and a Q score of 40 indicates a 1 in 10,000 probability, etc.). For every base call in every sequencing read in a DNA sequencing experiment, an associated Q score records the probability of the base-call being correct. The sequence data (base calls) and Q score data are then associated with each other and saved, most commonly through the widely used FASTQ data format which combines sequencing data and associated Q scores in a single data file.

In the context of flow cytometry, as in the present invention, a single flow cytometry measurement event (e.g., measurement of a single particle) is analogous to a single sequencing read; a single measurement parameter associated with a measurement event is analogous to a single base-call; a per-parameter, per-event flow cytometry uncertainty score is analogous to a Q score; and a modified FCS or new “FCSQ” format is analogous to the FASTQ format. Several important properties of Q scores are present in embodiments of the present invention, including, for example, the use of compressed Q score representations to save storage space, and the use of aggregate Q score metrics to indicate the overall read quality of a given sequence (flow cytometry event) or sequencing dataset (flow cytometry sample data).

Some important differences between sequencing Q scores and embodiments of the present invention include, for example, that sequencing data have a discrete-valued domain (A, C, G, or T) compared to flow cytometry data's continuous value domains (float or integer numbers), and the fact that sequencing errors are described in terms of binary classification error (the base call is either correct or incorrect) while, in embodiments, flow cytometry measurement error for a given parameter can be defined continuously (the measured parameter has some numerical degree of uncertainty described in terms of standard deviation or standard error of the mean, for example). In embodiments, flow cytometry gating classification is also a binary classification problem (an event belongs within a gated population, or does not, depending on whether corresponding event data falls within the ranges associated with the gated population or does not) and in that sense would exhibit similarly to a sequencing Q score. In embodiments, the term “binary classification” refers to dividing event data (e.g., flow cytometric events) into two distinct populations (i.e., determining whether an event is classified as belonging to a population or not belonging to such population). In some cases, binary classification of flow cytometric data is performed using classification trees. In some cases, binary classification of flow cytometric data is performed using hierarchical gates. As described above, in some embodiments, binary classification in the context of flow cytometry is a form of dichotomization in which a continuous function is transformed into a binary variable; continuous values can be made binary by defining a cutoff value; such cutoff value is then used to classify whether the corresponding event is positive or negative based on whether the event data value is higher or lower than the cutoff.

### Uncertainty Estimation Methods:

In embodiments, there are many methods by which measurement uncertainty metrics used in connection with embodiments may be estimated for a flow cytometry dataset. In embodiments, any convenient technique by which measurement uncertainty may be estimated may be employed in embodiments. Examples employed in embodiments are described herein. However, the present invention is not limited to such metrics, and in embodiments, any metric that quantifies measurement uncertainty may be employed. In one embodiment, measurement uncertainty may be calculated from a semi-empirical noise model that combines instrument calibration data, a physical noise model, and the measurement values corresponding to a given event. FIG. 1E, subpanels A, B and C, illustrates an exemplary processes for estimating measurement uncertainty, according to a “GLS unmixing approach.” Further details regarding such exemplary technique may be found in U.S. application Ser. No. 18/986,295, which claims priority to U.S. Provisional Application No. 63/622,370, the disclosure of which is incorporated herein in its entirety.

In another embodiment, measurement uncertainty is estimated post-hoc on a per-event basis using a statistical algorithm configured to measure properties of data distributions within the sample. In yet another embodiment, a combination of a priori noise modeling and a posteriori distribution fitting may be employed, using approaches such as Bayesian inference.

### Uncertainty Score Metrics:

In embodiments, the specific numerical metric used to report uncertainty may comprise any metric of measurement uncertainty and such may vary. Further, in embodiments, the type of metric may vary by parameter. That is, for a given event, in which a plurality of parameter measurements are associated, in embodiments, each parameter may have a different measurement uncertainty metric applied to it. In embodiments, uncertainty scores may also be reported for binary classification results arising from analysis, e.g., gating, population membership, etc. (In embodiments, gating in the context of flow cytometry refers to a process used to isolate specific event populations from a larger sample based on characteristics like size, granularity, and fluorescence, etc. In embodiments, population membership or population gating refers to a process of classification of events into populations or subpopulations based on specific characteristics, such as size, morphology, and protein expression, etc.) These may be reported as an uncertainty score (i.e., in which a higher value indicates higher uncertainty) or as a quality score (i.e., in which a higher value indicates higher confidence). In embodiments, uncertainty scores for an event of other binary classification results, for example, may be derived from other per-parameter uncertainty scores. Example metrics of interest include, for example: direct quantification (e.g., standard deviation); a confidence interval; a likelihood that an event's measured value is within some percent of its true value; or residuals describing the goodness-of-fit of unmixed data. In embodiments, a confidence interval is a range of values that is likely to contain the value of an unknown population parameter. Such intervals represent a plausible range for the parameter given the characteristics of the sample. Confidence intervals are derived from sample statistics and are calculated using a specified confidence level. That is, estimates of statistical values based on samples of populations involve uncertainty, and a confidence interval specifies a range of values in which such estimated statistic is expected to fall a certain percentage of the time an experiment is run or a population is re-sampled. The confidence level is the percentage of times it is expected to reproduce an estimate between the upper and lower bounds of the confidence interval. For example, for a confidence interval with a 95% confidence level, it can be expected that 95 out of 100 times an estimate will fall between the upper and lower values specified by the confidence interval.

### Gating Quality Scores:

Embodiments of the present invention may comprise calculating a gating quality score. In embodiments, a quality score may be calculated that estimates the likelihood of an event's membership in a given gate. This likelihood may be defined for each gate in a gating hierarchy, or may be defined hierarchically where the likelihood of membership in all of a gate's parent gates is taken into account. FIG. 1B illustrates hierarchical gates and associated likelihoods of membership for exemplary hierarchical gates.

### Applications:

Uncertainty scores as calculated by embodiments of the present invention find use in a number of different contexts, including, but not limited to: assessment of statistical significance or confidence intervals for event classification; use in variance-stabilizing transforms for data visualization and analysis; use in data preprocessing to minimize intra-cluster variance in supervised or unsupervised clustering techniques; use in data standardization to normalize measurement uncertainty across datasets measured on different instruments or under different conditions; and use in probabilistic analysis for cell classification and sorting (“fuzzy logic”).

### Format and Data Storage:

In embodiments, uncertainty scores or measurements or results could be stored and associated with measurement data (e.g., raw flow cytometric data or compensated or unmixed cytometric data) in any convenient way, and such may vary. FIG. 1F illustrates measurement data storage according to existing techniques, in which measurement data is ultimately stored 170 in an FCS file format, but no per-parameter or per-event or per-gate or per-sample or other measure of measurement uncertainty is estimated or calculated or recorded.

FIG. 1G shows how embodiments of the present invention may record measurement data along with measurement uncertainty data. Multi-file model 171 according to an embodiment comprises a single shared data record: uncertainty scores are added as additional event-specific FCS parameters (e.g., for measurement parameter “FITC-A”, an additional measurement parameter “FITC-A-Uncertainty” would also be saved). This multi-file approach 171 is a simple solution and exhibits certain similarities to the sequencing FASTQ implementation described herein. A disadvantage or downside to the multi-file model approach 171 would be increased file size and data storage requirements. Only FCS3.2+ formats would yield the storage-space benefits of a compressed uncertainty score (e.g., 1 byte instead of 4 bytes) since earlier FCS formats store all values as 32-bit floats.

Other embodiments utilize a split data record approach 172: a separate data file (for example, named .FCSQ) comprising uncertainty scores would be generated alongside a typical flow data file (.FCS) (i.e., according to existing techniques). In embodiments, the split data record approach allows for uncertainty scores to be provided for all or only some of the parameters in the .FCS file.

In embodiments, aggregate uncertainty scores at the population or recording level could be stored in the .FCS file header as additional keywords.

In embodiments, to support reproducibility and traceability, all metadata necessary for generating the uncertainty scores for a given recording (including instrument calibration parameters and noise model information) could be saved in the .FCS file header.

### Methods

Aspects of the present disclosure include methods for identifying measurement uncertainty associated with light detected from a sample. Methods according to certain embodiments include introducing a sample into a flow cytometer, flowing the introduced sample in a flow stream, irradiating the sample in the flow stream with a light source, detecting light from particles in the sample flowing in the flow stream and, identifying measurement uncertainty associated with the detected light. In some embodiments, measurement uncertainty is identified corresponding to individual particles in the sample. In certain embodiments, measurement uncertainty is identified for individual parameters of detected light for particles in the sample. Methods according to some embodiments further comprise generating a quality score for each particle based on the measurement uncertainty for each particle.

In embodiments, detecting light from particles comprises measuring a plurality of parameters of the detected light for particles in the sample. Certain embodiments further comprise further comprise: generating event data based on the detected light, wherein event data comprises parameter measurements for particles in the sample. Other embodiments further comprise: spectrally resolving the light detected from particles. In some cases, spectrally resolving the light detected from particles produces a plurality of derived parameters. Embodiments of methods of the disclosure further comprise: generating a plurality of derived parameters for each particle by spectrally resolving the light detected from each particle. In some cases, the derived parameters comprise unmixed detected light. In other cases, measurement uncertainty is identified for derived parameters.

Embodiments further comprise: identifying a first subset of particles in the sample by applying a first gate to the detected light. In embodiments, measurement uncertainty corresponds to identifying the first subset of particles. Methods of interest further comprise: identifying a plurality of subsets of particles in the sample by applying a corresponding plurality of gates to the detected light. In some cases, measurement uncertainty corresponds to identifying each of the plurality of subsets of particles. In embodiments, measurement uncertainty corresponds to gate-level uncertainty.

Embodiments of methods of the disclosure further comprise: generating a quality score (Q score) for each particle based on the measurement uncertainty for each particle. Other embodiments further comprise: recording each event and associated measurement uncertainty for each event. Still other embodiments further comprise: recording measurements for each particle and associated measurement uncertainty for each particle. Certain other embodiments further comprise: recording measurements for a plurality of parameters for each particle and associated measurement uncertainty for each parameter of each particle. Embodiments further comprise: recording measurement uncertainty, wherein the measurement uncertainty corresponds to measurement uncertainty for one or more of: each recorded parameter; each recorded event; each gate or other classification; or for the sample.

In embodiments, the measurement uncertainty for different parameters measured for particles in the sample comprises a different metric. In some embodiments, the measurement uncertainty corresponds to a binary classification event. In such cases, the binary classification event may correspond to one or more of: a gating determination or a population membership classification decision. In embodiments, the measurement uncertainty comprises a metric that quantifies measurement uncertainty. Methods of interest further comprise: generating an uncertainty score based on the measurement uncertainty. In embodiments, measurement uncertainty is reflected in an uncertainty score, wherein higher value uncertainty scores indicates greater measurement uncertainty. Other methods of interest further comprise: generating a quality score based on the measurement uncertainty. In embodiments, the measurement uncertainty is reflected in a quality score, wherein higher value quality score indicates higher confidence.

In embodiments, the measurement uncertainty comprises one or more of: direct quantification, optionally comprising a standard deviation; a confidence interval; a likelihood that a measured value is within a specified percent of a true value; or a residual related to a goodness-of-fit of unmixed data. In some embodiments, the measurement uncertainty relates to a binary classification, wherein the binary classification optionally comprises one or more of gating or population membership classifications.

Embodiments of methods of the disclosure further comprise: calculating a quality score based on the measurement uncertainty, wherein the quality score reflects a likelihood of membership in a gate. In embodiments, the likelihood of membership in the gate is calculated for each gate in a gate hierarchy. In other embodiments, the likelihood of membership in the gate is calculated taking into account each hierarchical parent gate of the gate. In other embodiments, identifying measurement uncertainty associated with the detected light comprises: calculating measurement uncertainty based on a semi-empirical noise model, wherein the semi-empirical noise model comprises one or more of: instrument calibration data, a physical noise model, or measurement values. In still other embodiments, identifying measurement uncertainty associated with the detected light comprises: estimating measurement uncertainty on a per event basis based on a statistical algorithm, wherein the statistical algorithm comprises measuring properties of data distributions within the sample.

In embodiments, identifying measurement uncertainty associated with the detected light comprises: estimating measurement uncertainty comprises applying a combination of noise modeling and distribution fitting. In some embodiments, identifying measurement uncertainty associated with the detected light comprises: estimating measurement uncertainty comprises applying Bayesian inference.

Embodiments of interest further comprise: reporting measurement uncertainty for each particle of a subset of particles of the sample. Other embodiments further comprise: reporting measurement uncertainty for a plurality of parameters for each particle of a subset of particles of the sample. Still other embodiments further comprise: reporting measurement uncertainty associated with membership in a subpopulation defined by a gate for each particle in a subset of particles.

In embodiments, measurement uncertainty comprises random measurement error. In some embodiments, measurement uncertainty comprises spillover-spreading error. In other embodiments, measurement uncertainty reflects variations other than true intrinsic differences between particles of the sample. In still other embodiments, measurement uncertainty reflects confidence in a classification decision regarding particles of the sample. In some cases, measurement uncertainty reflects an aggregate measurement uncertainty related to a plurality of parameter measurements of light detected from particles. In other cases, measurement uncertainty reflects an aggregate measurement uncertainty related to measurements of light detected from a plurality of particles. In still other cases, measurement uncertainty reflects an aggregate measurement uncertainty related to the sample.

In embodiments, identifying measurement uncertainty associated with the detected light comprises one or more of: estimating measurement uncertainty associated with the detected light, measuring measurement uncertainty associated with the detected light, or predicting measurement uncertainty associated with the detected light.

Methods of interest further comprise: classifying particles based on detected light; and calculating a statistical significance for classification of particles based at least in part on the measurement uncertainty. Other methods of interest further comprise: classifying particles based on detected light; and calculating a confidence interval for classification of particles based at least in part on the measurement uncertainty. Still other methods of interest further comprise: applying a variance-stabilizing transform to data comprising measurements of light detected from particles in the sample based at least in part on the measurement uncertainty; and visualizing aspects of the transformed data. Certain embodiments further comprise: preprocessing data comprising measurements of light detected from particles in the sample to minimize intra-cluster variance based at least in part on the measurement uncertainty; and applying a clustering algorithm to the preprocessed data, wherein the clustering algorithm optionally comprises one or more of a supervised clustering algorithm and an unsupervised clustering algorithm. Other embodiments further comprise: standardizing data comprising measurements of light detected from particles in the sample to normalize measurement uncertainty across different datasets based at least in part on the measurement uncertainty, wherein the different data sets optionally comprise one or more of datasets collected on different instruments or datasets collected under different conditions. In some cases, methods further comprise: using the measurement uncertainty for probabilistic analysis of particle classification or sorting, wherein the probabilistic classification optionally comprises applying a fuzzy logic technique.

In embodiments, the method is a method of distinguishing true variability in the particles of the sample from measurement error. In other embodiments, the method is a method of distinguishing true biological variability from measurement error. In still other embodiments, the method is a method of improving sensitivity of flow cytometry assays. In some cases, the method is a method of improving resolving power of flow cytometry assays. In other cases, the method is a method for assessing a quality of particle analysis results by associating event-specific estimates of measurement uncertainty with flow cytometry measurements.

In embodiments, a quantitative metric of measurement uncertainty is associated with flow cytometry measurement. Embodiments further comprise: using measurement uncertainty in connection with data analysis or sorting. Some embodiments further comprise: identifying a gate membership confidence score for each event and each gate, wherein the gate membership confidence score comprises a likelihood that a true biological expression level for a given event falls within a given gate.

In some cases, the method is a method for calculating gate membership confidence scores. Some embodiments further comprise: using gate membership confidence scores based on measurement uncertainty in particle classification and sorting, wherein particle classification and sorting comprises probabilistic sorting with configurable likelihood thresholds to maximize purity and/or yield.

In embodiments, light is detected with a light detection system. In some cases, light is detected by the light detection system in a plurality of photodetector channels. In other cases, the light detection system comprises a plurality of photodetectors.

FIG. 1H depicts a flow diagram 180 for identifying measurement uncertainty and classification uncertainty of flow cytometry data according to certain embodiments. As discussed in greater detail herein, at step 181, a sample is introduced into a flow cytometer; at step 182, the sample is flowed in a flow stream; at step 183, the sample in the flow stream is irradiated with a light source; at step 184, light is detected from particles in the sample flowing in the flow stream; at step 185, measurement uncertainty associated with the detected light is identified. Further details regarding each of steps 181, 182, 183, 184 and 185 are described herein.

In some instances, the sample analyzed in the instant methods is a biological sample. The term “biological sample” is used in its conventional sense to refer to a whole organism, plant, fungi or a subset of animal tissues, cells or component parts which may in certain instances be found in blood, mucus, lymphatic fluid, synovial fluid, cerebrospinal fluid, saliva, bronchoalveolar lavage, amniotic fluid, amniotic cord blood, urine, vaginal fluid and semen. As such, a “biological sample” refers to both the native organism or a subset of its tissues as well as to a homogenate, lysate or extract prepared from the organism or a subset of its tissues, including but not limited to, for example, plasma, serum, spinal fluid, lymph fluid, sections of the skin, respiratory, gastrointestinal, cardiovascular, and genitourinary tracts, tears, saliva, milk, blood cells, tumors, organs. Biological samples may be any type of organismic tissue, including both healthy and diseased tissue (e.g., cancerous, malignant, necrotic, etc.). In certain embodiments, the biological sample is a liquid sample, such as blood or derivative thereof, e.g., plasma, tears, urine, semen, etc., where in some instances the sample is a blood sample, including whole blood, such as blood obtained from venipuncture or fingerstick (where the blood may or may not be combined with any reagents prior to assay, such as preservatives, anticoagulants, etc.).

In certain embodiments the source of the sample is a “mammal” or “mammalian”, where these terms are used broadly to describe organisms which are within the class Mammalia, including the orders carnivore (e.g., dogs and cats), Rodentia (e.g., mice, guinea pigs, and rats), and primates (e.g., humans, chimpanzees, and monkeys). In some instances, the subjects are humans. The methods may be applied to samples obtained from human subjects of both genders and at any stage of development (i.e., neonates, infant, juvenile, adolescent, adult), where in certain embodiments the human subject is a juvenile, adolescent or adult. While the present disclosure may be applied to samples from a human subject, it is to be understood that the methods may also be carried-out on samples from other animal subjects (that is, in “non-human subjects”) such as, but not limited to, birds, mice, rats, dogs, cats, livestock and horses.

Cells of interest may be targeted for characterized according to a variety of parameters, such as a phenotypic characteristic identified via the attachment of a particular fluorescent label to cells of interest. In some embodiments, the system is configured to deflect analyzed droplets that are determined to include a target cell. A variety of cells may be characterized using the subject methods. Target cells of interest include, but are not limited to, stem cells, T cells, dendritic cells, B Cells, granulocytes, leukemia cells, lymphoma cells, virus cells (e.g., HIV cells), NK cells, macrophages, monocytes, fibroblasts, epithelial cells, endothelial cells, and erythroid cells. Target cells of interest include cells that have a convenient cell surface marker or antigen that may be captured or labelled by a convenient affinity agent or conjugate thereof. For example, the target cell may include a cell surface antigen such as CD11b, CD123, CD14, CD15, CD16, CD19, CD193, CD2, CD25, CD27, CD3, CD335, CD36, CD4, CD43, CD45RO, CD56, CD61, CD7, CD8, CD34, CD1c, CD23, CD304, CD235a, T cell receptor alpha/beta, T cell receptor gamma/delta, CD253, CD95, CD20, CD105, CD117, CD120b, Notch4, Lgr5 (N-Terminal), SSEA-3, TRA-1-60 Antigen, Disialoganglioside GD2 and CD71. In some embodiments, the target cell is selected from HIV containing cell, a Treg cell, an antigen-specific T-cell populations, tumor cells or hematopoietic progenitor cells (CD34+) from whole blood, bone marrow or cord blood.

In practicing the subject methods, an amount of an initial fluidic sample is injected into the flow cytometer. The amount of sample injected into the particle sorting module may vary, for example, ranging from 0.001 mL to 1000 mL, such as from 0.005 mL to 900 mL, such as from 0.01 mL to 800 mL, such as from 0.05 mL to 700 mL, such as from 0.1 mL to 600 mL, such as from 0.5 mL to 500 mL, such as from 1 mL to 400 mL, such as from 2 mL to 300 mL and including from 5 mL to 100 ml of sample.

Methods according to embodiments of the present disclosure include counting and optionally sorting labeled particles (e.g., target cells) in a sample. In practicing the subject methods, the fluidic sample including the particles is first introduced into a flow nozzle of the system. Upon exit from the flow nozzle, the particles are passed substantially one at a time through the sample interrogation region where each of the particles is irradiated to a source of light and measurements of light scatter parameters and, in some instances, fluorescent emissions as desired (e.g., two or more light scatter parameters and measurements of one or more fluorescent emissions) are separately recorded for each particle. Depending on the properties of the flow stream being interrogated, 0.001 mm or more of the flow stream may be irradiated with light, such as 0.005 mm or more, such as 0.01 mm or more, such as 0.05 mm or more, such as 0.1 mm or more, such as 0.5 mm or more and including 1 mm or more of the flow stream may be irradiated with light. In certain embodiments, methods include irradiating a planar cross-section of the flow stream in the sample interrogation region, such as with a laser (as described above). In other embodiments, methods include irradiating a predetermined length of the flow stream in the sample interrogation region, such as corresponding to the irradiation profile of a diffuse laser beam or lamp.

In certain embodiments, methods including irradiating the flow stream at or near the flow cell nozzle orifice. For example, methods may include irradiating the flow stream at a position about 0.001 mm or more from the nozzle orifice, such as 0.005 mm or more, such as 0.01 mm or more, such as 0.05 mm or more, such as 0.1 mm or more, such as 0.5 mm or more and including 1 mm or more from the nozzle orifice. In certain embodiments, methods include irradiating the flow stream immediately adjacent to the flow cell nozzle orifice.

In embodiments of the method, detectors, such as photomultiplier tubes (PMT), are used to record light that passes through each particle (in certain cases referred to as forward light scatter), light that is reflected orthogonal to the direction of the flow of the particles through the sensing region (in some cases referred to as orthogonal or side light scatter) and fluorescent light emitted from the particles, if it is labeled with fluorescent marker(s), as the particle passes through the sensing region and is illuminated by the energy source. Each of forward light scatter (FSC), side-scatter (SSC), and fluorescence emissions include a separate parameter for each particle (or each “event”). Thus, for example, two, three or four parameters can be collected (and recorded) from a particle labeled with two different fluorescence markers. The data recorded for each particle is analyzed in real time or stored in a data storage and analysis means, such as a computer, as desired.

In certain embodiments, the particles are detected and uniquely identified by exposing the particles to excitation light and measuring the fluorescence of each particle in one or more detection channels, as desired. Fluorescence emitted in detection channels used to identify the particles and binding complexes associated therewith may be measured following excitation with a single light source, or may be measured separately following excitation with distinct light sources. If separate excitation light sources are used to excite the particle labels, the labels may be selected such that all the labels are excitable by each of the excitation light sources used.

Methods in certain embodiments also include data acquisition, analysis and recording, such as with a computer, wherein multiple data channels record data from each detector for the light scatter and fluorescence emitted by each particle as it passes through the sample interrogation region of the particle sorting module. In these embodiments, analysis includes classifying and counting particles such that each particle is present as a set of digitized parameter values. The subject systems may be set to trigger on a selected parameter in order to distinguish the particles of interest from background and noise. “Trigger” refers to a preset threshold for detection of a parameter and may be used as a means for detecting passage of a particle through the light source. Detection of an event that exceeds the threshold for the selected parameter triggers acquisition of light scatter and fluorescence data for the particle. Data is not acquired for particles or other components in the medium being assayed which cause a response below the threshold. The trigger parameter may be the detection of forward-scattered light caused by passage of a particle through the light beam. The flow cytometer then detects and collects the light scatter and fluorescence data for the particle.

A particular subpopulation of interest is then further analyzed by “gating” based on the data collected for the entire population. To select an appropriate gate, the data is plotted so as to obtain the best separation of subpopulations possible. This procedure may be performed by plotting forward light scatter (FSC) vs. side (i.e., orthogonal) light scatter (SSC) on a two dimensional dot plot. A subpopulation of particles is then selected (i.e., those cells within the gate) and particles that are not within the gate are excluded. Where desired, the gate may be selected by drawing a line around the desired subpopulation using a cursor on a computer screen. Only those particles within the gate are then further analyzed by plotting the other parameters for these particles, such as fluorescence. Where desired, the above analysis may be configured to yield counts of the particles of interest in the sample.

Methods of interest may further include employing particles in research, laboratory testing, or therapy. In some embodiments, the subject methods include obtaining individual cells prepared from a target fluidic or tissue biological sample. For example, the subject methods include obtaining cells from fluidic or tissue samples to be used as a research or diagnostic specimen for diseases such as cancer. Likewise, the subject methods include obtaining cells from fluidic or tissue samples to be used in therapy. A cell therapy protocol is a protocol in which viable cellular material including, e.g., cells and tissues, may be prepared and introduced into a subject as a therapeutic treatment. Conditions that may be treated by the administration of the flow cytometrically sorted sample include, but are not limited to, blood disorders, immune system disorders, organ damage, etc.

A typical cell therapy protocol may include the following steps: sample collection, cell isolation, genetic modification, culture, and expansion in vitro, cell harvesting, sample volume reduction and washing, bio-preservation, storage, and introduction of cells into a subject. The protocol may begin with the collection of viable cells and tissues from source tissues of a subject to produce a sample of cells and/or tissues. The sample may be collected via any suitable procedure that includes, e.g., administering a cell mobilizing agent to a subject, drawing blood from a subject, removing bone marrow from a subject, etc. After collecting the sample, cell enrichment may occur via several methods including, e.g., centrifugation based methods, filter based methods, elutriation, magnetic separation methods, fluorescence-activated cell sorting (FACS), and the like. In some cases, the enriched cells may be genetically modified by any convenient method, e.g., nuclease mediated gene editing. The genetically modified cells can be cultured, activated, and expanded in vitro. In some cases, the cells are preserved, e.g., cryopreserved, and stored for future use where the cells are thawed and then administered to a patient, e.g., the cells may be infused in the patient.

Systems for Identifying Measurement Uncertainty Associated with Light Detected from a Sample

As summarized above, aspects of the present disclosure include a system for identifying measurement uncertainty associated with light detected from a sample. In embodiments of systems are configured for practicing the subject methods. Aspects of the disclosure also include flow cytometers. Flow cytometers of interest include a light source configured to irradiate the particles in the flow stream at an interrogation point within a flow cell. Flow cytometers of interest further include a light detection system comprising a plurality of photodetectors.

Flow cells of interest include a cuvette configured to transport particles in a flow stream. As discussed herein, a “flow cell” is described in its conventional sense to refer to a component containing a flow channel for a liquid flow stream for transporting particles in a sheath fluid. Cuvettes of interest have a passage (i.e., flow channel) running therethrough. The flow stream for which the flow channel is configured may include a liquid sample injected from a sample tube. In certain instances, the flow cell includes a light-accessible flow channel. The cuvette may be comprised of, e.g., quartz, glass, clear plastic, and the like. In some embodiments, cuvettes are formed from silica, such as fused silica. In some cases, the flow cell is configured for irradiation with light from a light source at one or more interrogation points. The “interrogation point” discussed herein refers to a region within the flow cell in which the particle is irradiated by light from the light source, e.g., for analysis. The size of the interrogation point may vary as desired. For example, where 0 μm represents the optical axis of light emitted by the light source, the interrogation point may range from −50 μm to 50 μm, such as −25 μm to 40 μm, and including −15 μm to 30 μm. Depending on certain considerations (e.g., the number and arrangement of lasers), multiple irradiation points may exist within the flow cells.

In some embodiments, the flow cell includes, or is configured for use with, a sample injection port configured to provide a sample to the flow cell. In embodiments, the sample injection system is configured to provide suitable flow of sample to the flow cell inner chamber (i.e., flow channel). Depending on the desired characteristics of the flow stream, the rate of sample conveyed to the flow cell chamber by the sample injection port may be 1 μL/min or more, such as 2 μL/min or more, such as 3 μL/min or more, such as 5 μL/min or more, such as 10 μL/min or more, such as 15 μL/min or more, such as 25 μL/min or more, such as 50 L/min or more and including 100 μL/min or more, where in some instances the rate of sample conveyed to the flow cell chamber by the sample injection port is 1 μL/sec or more, such as 2 μL/sec or more, such as 3 μL/sec or more, such as 5 μL/sec or more, such as 10 μL/sec or more, such as 15 μL/sec or more, such as 25 μL/sec or more, such as 50 μL/sec or more and including 100 L/sec or more.

The sample injection port may be an orifice positioned in a wall of the inner chamber or may be a conduit positioned at the proximal end of the inner chamber. Where the sample injection port is an orifice positioned in a wall of the inner chamber, the sample injection port orifice may be any suitable shape where cross-sectional shapes of interest include, but are not limited to: rectilinear cross-sectional shapes, e.g., squares, rectangles, trapezoids, triangles, hexagons, etc., curvilinear cross-sectional shapes, e.g., circles, ovals, etc., as well as irregular shapes, e.g., a parabolic bottom portion coupled to a planar top portion. In certain embodiments, the sample injection port has a circular orifice. The size of the sample injection port orifice may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

In certain instances, the sample injection port is a conduit positioned at a proximal end of the flow cell inner chamber. For example, the sample injection port may be a conduit positioned to have the orifice of the sample injection port in line with the flow cell orifice. Where the sample injection port is a conduit positioned in line with the flow cell orifice, the cross-sectional shape of the sample injection tube may be any suitable shape where cross-sectional shapes of interest include, but are not limited to: rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The orifice of the conduit may vary depending on shape, in certain instances, having an opening ranging from 0.1 mm to 5.0 mm, e.g., 0.2 to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm. The shape of the tip of the sample injection port may be the same or different from the cross-section shape of the sample injection tube. For example, the orifice of the sample injection port may include a beveled tip having a bevel angle ranging from 1° to 10°, such as from 2° to 9°, such as from 3° to 8°, such as from 4° to 7° and including a bevel angle of 5°.

In some embodiments, the flow cell also includes a sheath fluid injection port configured to provide a sheath fluid to the flow cell. In embodiments, the sheath fluid injection system is configured to provide a flow of sheath fluid to the flow cell inner chamber, for example in conjunction with the sample to produce a laminated flow stream of sheath fluid surrounding the sample flow stream. Depending on the desired characteristics of the flow stream, the rate of sheath fluid conveyed to the flow cell chamber by the may be 25 μL/sec or more, such as 50 μL/sec or more, such as 75 μL/sec or more, such as 100 μL/sec or more, such as 250 μL/sec or more, such as 500 μL/sec or more, such as 750 μL/sec or more, such as 1000 μL/sec or more and including 2500 μL/sec or more.

In some embodiments, the sheath fluid injection port is an orifice positioned in a wall of the inner chamber. The sheath fluid injection port orifice may be any suitable shape where cross-sectional shapes of interest include, but are not limited to: rectilinear cross-sectional shapes, e.g., squares, rectangles, trapezoids, triangles, hexagons, etc., curvilinear cross-sectional shapes, e.g., circles, ovals, as well as irregular shapes, e.g., a parabolic bottom portion coupled to a planar top portion. The size of the sheath fluid injection port orifice may vary depending on shape, in certain instances, having an opening ranging from 0.1 mm to 5.0 mm, e.g., 0.2 mm to 3.0 mm, e.g., 0.5 mm to 2.5 mm, such as from 0.75 mm to 2.25 mm, such as from 1 mm to 2 mm and including from 1.25 mm to 1.75 mm, for example 1.5 mm.

Flow cytometers of the present disclosure include a light source configured to irradiate the particles in the flow stream at an interrogation point within the flow cell. The number of light sources in the flow cytometers may vary. In some embodiments, flow cytometers include a single light source. Alternatively, flow cytometers may in some instances include a plurality of light sources. In some such instances, the number of light sources ranges from 2 to 10, such as 2 to 5, and including 2 to 4. Any convenient light source may be employed as the light source described herein. In some embodiments, the light source is a laser. In embodiments, the laser may be any convenient laser, such as a continuous wave laser. For example, the laser may be a diode laser, such as an ultraviolet diode laser, a visible diode laser and a near-infrared diode laser. In other embodiments, the laser may be a helium-neon (HeNe) laser. In some instances, the laser is a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCl) excimer laser or xenon-fluorine (XeF) excimer laser or a combination thereof. In other instances, the subject flow cytometers include a dye laser, such as a stilbene, coumarin or rhodamine laser. In yet other instances, lasers of interest include a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, the subject flow cytometers include a solid-state laser, such as a ruby laser, an Nd: YAG laser, NdCrYAG laser, Er: YAG laser, Nd: YLF laser, Nd: YVO₄ laser, Nd: YCa₄O(BO₃)₃ laser, Nd: YCOB laser, titanium sapphire laser, thulium YAG laser, ytterbium YAG laser, ytterbium₂O₃ laser or cerium doped lasers and combinations thereof.

Laser light sources according to certain embodiments may also include one or more optical adjustment components. In certain embodiments, the optical adjustment component is located between the light source and the flow cell, and may include any device that is capable of changing the spatial width of irradiation or some other characteristic of irradiation from the light source, such as for example, irradiation direction, wavelength, beam width, beam intensity and focal spot. Optical adjustment protocols may include any convenient device which adjusts one or more characteristics of the light source, including but not limited to lenses, mirrors, filters, fiber optics, wavelength separators, pinholes, slits, collimating protocols and combinations thereof. In certain embodiments, flow cytometers of interest include one or more focusing lenses. The focusing lens, in one example, may be a de-magnifying lens. In still other embodiments, flow cytometers of interest include fiber optics.

The light source may be positioned any suitable distance from the flow cell, such as where the light source and the flow cell are separated by 0.005 mm or more, such as 0.01 mm or more, such as 0.05 mm or more, such as 0.1 mm or more, such as 0.5 mm or more, such as 1 mm or more, such as 5 mm or more, such as 10 mm or more, such as 25 mm or more and including at a distance of 100 mm or more. In addition, the light source may be positioned at any suitable angle relative to the flow cell, such as at an angle ranging from 10 degrees to 90 degrees, such as from 15 degrees to 85 degrees, such as from 20 degrees to 80 degrees, such as from 25 degrees to 75 degrees and including from 30 degrees to 60 degrees, for example at a 90 degree angle.

In some embodiments, light sources of interest include a plurality of lasers configured to provide laser light for discrete irradiation of the flow stream, such as 2 lasers or more, such as 3 lasers or more, such as 4 lasers or more, such as 5 lasers or more, such as 10 lasers or more, and including 15 lasers or more configured to provide laser light for discrete irradiation of the flow stream. Depending on the desired wavelengths of light for irradiating the flow stream, each laser may have a specific wavelength that varies from 200 nm to 1500 nm, such as from 250 nm to 1250 nm, such as from 300 nm to 1000 nm, such as from 350 nm to 900 nm and including from 400 nm to 800 nm. In certain embodiments, lasers of interest may include one or more of a 405 nm laser, a 488 nm laser, a 561 nm laser and a 635 nm laser.

In certain embodiments, the light source is a light beam generator that is configured to generate two or more beams of frequency shifted light. In some instances, the light beam generator includes a laser, a radiofrequency generator configured to apply radiofrequency drive signals to an acousto-optic device to generate two or more angularly deflected laser beams. In these embodiments, the laser may be a pulsed lasers or continuous wave laser. For example, lasers in light beam generators of interest include those listed above.

The acousto-optic device may be any convenient acousto-optic protocol configured to frequency shift laser light using applied acoustic waves. In certain embodiments, the acousto-optic device is an acousto-optic deflector. The acousto-optic device in the subject system is configured to generate angularly deflected laser beams from the light from the laser and the applied radiofrequency drive signals. The radiofrequency drive signals may be applied to the acousto-optic device with any suitable radiofrequency drive signal source, such as a direct digital synthesizer (DDS), arbitrary waveform generator (AWG), or electrical pulse generator.

In embodiments, a controller is configured to apply radiofrequency drive signals to the acousto-optic device to produce the desired number of angularly deflected laser beams in the output laser beam, such as being configured to apply 3 or more radiofrequency drive signals, such as 4 or more radiofrequency drive signals, such as 5 or more radiofrequency drive signals, such as 6 or more radiofrequency drive signals, such as 7 or more radiofrequency drive signals, such as 8 or more radiofrequency drive signals, such as 9 or more radiofrequency drive signals, such as 10 or more radiofrequency drive signals, such as 15 or more radiofrequency drive signals, such as 25 or more radiofrequency drive signals, such as 50 or more radiofrequency drive signals and including being configured to apply 100 or more radiofrequency drive signals.

In some instances, to produce an intensity profile of the angularly deflected laser beams in the output laser beam, the controller is configured to apply radiofrequency drive signals having an amplitude that varies such as from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In certain embodiments, the controller has a processor having memory operably coupled to the processor such that the memory includes instructions stored thereon, which when executed by the processor, cause the processor to produce an output laser beam with angularly deflected laser beams having a desired intensity profile. For example, the memory may include instructions to produce two or more angularly deflected laser beams with the same intensities, such as 3 or more, such as 4 or more, such as 5 or more, such as 10 or more, such as 25 or more, such as 50 or more and including memory may include instructions to produce 100 or more angularly deflected laser beams with the same intensities. In other embodiments, the memory may include instructions to produce two or more angularly deflected laser beams with different intensities, such as 3 or more, such as 4 or more, such as 5 or more, such as 10 or more, such as 25 or more, such as 50 or more and including memory may include instructions to produce 100 or more angularly deflected laser beams with different intensities.

In certain embodiments, the controller has a processor having memory operably coupled to the processor such that the memory includes instructions stored thereon, which when executed by the processor, cause the processor to produce an output laser beam having increasing intensity from the edges to the center of the output laser beam along the horizontal axis. In these instances, the intensity of the angularly deflected laser beam at the center of the output beam may range from 0.1% to about 99% of the intensity of the angularly deflected laser beams at the edge of the output laser beam along the horizontal axis, such as from 0.5% to about 95%, such as from 1% to about 90%, such as from about 2% to about 85%, such as from about 3% to about 80%, such as from about 4% to about 75%, such as from about 5% to about 70%, such as from about 6% to about 65%, such as from about 7% to about 60%, such as from about 8% to about 55% and including from about 10% to about 50% of the intensity of the angularly deflected laser beams at the edge of the output laser beam along the horizontal axis. In other embodiments, the controller has a processor having memory operably coupled to the processor such that the memory includes instructions stored thereon, which when executed by the processor, cause the processor to produce an output laser beam having an increasing intensity from the edges to the center of the output laser beam along the horizontal axis. In these instances, the intensity of the angularly deflected laser beam at the edges of the output beam may range from 0.1% to about 99% of the intensity of the angularly deflected laser beams at the center of the output laser beam along the horizontal axis, such as from 0.5% to about 95%, such as from 1% to about 90%, such as from about 2% to about 85%, such as from about 3% to about 80%, such as from about 4% to about 75%, such as from about 5% to about 70%, such as from about 6% to about 65%, such as from about 7% to about 60%, such as from about 8% to about 55% and including from about 10% to about 50% of the intensity of the angularly deflected laser beams at the center of the output laser beam along the horizontal axis. In yet other embodiments, the controller has a processor having memory operably coupled to the processor such that the memory includes instructions stored thereon, which when executed by the processor, cause the processor to produce an output laser beam having an intensity profile with a Gaussian distribution along the horizontal axis. In still other embodiments, the controller has a processor having memory operably coupled to the processor such that the memory includes instructions stored thereon, which when executed by the processor, cause the processor to produce an output laser beam having a top hat intensity profile along the horizontal axis.

In embodiments, light beam generators of interest may be configured to produce angularly deflected laser beams in the output laser beam that are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1000 μm or more and including by 5000 μm or more. In some embodiments, systems are configured to produce angularly deflected laser beams in the output laser beam that overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

In certain instances, light beam generators configured to generate two or more beams of frequency shifted light include laser excitation modules as described in U.S. Pat. Nos. 9,423,353; 9,784,661; 9,983,132; 10,006,852; 10,036,699; 10,078,045; 10,222,316; 10,288,546; 10,324,019; 10,408,758; 10,451,538; 10,620,111; 10,684,211; 10,845,295; 10,935,482; 10,935,485; 11,105,728; 11,280,718; 11,327,016; 11,366,052; 11,371,937; 11,692,926; 11,630,053; 11,774,343; 11,940,369; and 11,946,851; the disclosures of which are herein incorporated by reference.

In addition, flow cytometers include a detector configured to collect light emitted by the irradiated particles. The light detectors are configured to detect particle-modulated light conveyed by the fiber optic light collection elements and generate signals based on a characteristic of that light (e.g., intensity). For example, the one or more particle-modulated light detector(s) may include one or more side-scattered light detectors for detecting side-scatter wavelengths of light (i.e., light refracted and reflected from the surfaces and internal structures of the particle). In some embodiments, flow cytometers include a single side-scattered light detector. In other embodiments, flow cytometers include multiple side-scattered light detectors, such as 2 or more, such as 3 or more, such as 4 or more, and including 5 or more.

Any convenient detector for detecting collected light may be used in the side-scattered light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from 0.1 cm² to 8 cm², such as from 0.5 cm² to 7 cm² and including from 1 cm² to 5 cm².

In embodiments, the subject flow cytometers also include a fluorescent light detector configured to detect one or more fluorescent wavelengths of light. In other embodiments, flow cytometers include multiple fluorescent light detectors such as 2 or more, such as 3 or more, such as 4 or more, 5 or more, 10 or more, 15 or more, and including 20 or more.

Any convenient detector for detecting collected light may be used in the fluorescent light detector described herein. Detectors of interest may include, but are not limited to, optical sensors or detectors, such as active-pixel sensors (APSs), avalanche photodiodes, image sensors, charge-coupled devices (CCDs), intensified charge-coupled devices (ICCDs), light emitting diodes, photon counters, bolometers, pyroelectric detectors, photoresistors, photovoltaic cells, photodiodes, photomultiplier tubes (PMTs), phototransistors, quantum dot photoconductors or photodiodes and combinations thereof, among other detectors. In certain embodiments, the collected light is measured with a charge-coupled device (CCD), semiconductor charge-coupled devices (CCD), active pixel sensors (APS), complementary metal-oxide semiconductor (CMOS) image sensors or N-type metal-oxide semiconductor (NMOS) image sensors. In certain embodiments, the detector is a photomultiplier tube, such as a photomultiplier tube having an active detecting surface area of each region that ranges from 0.01 cm² to 10 cm², such as from 0.05 cm² to 9 cm², such as from, such as from 0.1 cm² to 8 cm², such as from 0.5 cm² to 7 cm² and including from 1 cm² to 5 cm².

Where the subject flow cytometers include multiple fluorescent light detectors, each fluorescent light detector may be the same, or the collection of fluorescent light detectors may be a combination of different types of detectors. For example, where the subject flow cytometers include two fluorescent light detectors, in some embodiments the first fluorescent light detector is a CCD-type device and the second fluorescent light detector (or imaging sensor) is a CMOS-type device. In other embodiments, both the first and second fluorescent light detectors are CCD-type devices. In yet other embodiments, both the first and second fluorescent light detectors are CMOS-type devices. In still other embodiments, the first fluorescent light detector is a CCD-type device and the second fluorescent light detector is a photomultiplier tube (PMT). In still other embodiments, the first fluorescent light detector is a CMOS-type device and the second fluorescent light detector is a photomultiplier tube. In yet other embodiments, both the first and second fluorescent light detectors are photomultiplier tubes.

In embodiments of the present disclosure, fluorescent light detectors of interest are configured to measure collected light at one or more wavelengths, such as at 2 or more wavelengths, such as at 5 or more different wavelengths, such as at 10 or more different wavelengths, such as at 25 or more different wavelengths, such as at 50 or more different wavelengths, such as at 100 or more different wavelengths, such as at 200 or more different wavelengths, such as at 300 or more different wavelengths and including measuring light emitted by a sample in the flow stream at 400 or more different wavelengths. In some embodiments, 2 or more detectors in the modules as described herein are configured to measure the same or overlapping wavelengths of collected light.

In some embodiments, fluorescent light detectors of interest are configured to measure collected light over a range of wavelengths (e.g., 200 nm-1000 nm). In certain embodiments, detectors of interest are configured to collect spectra of light over a range of wavelengths. For example, flow cytometers may include one or more detectors configured to collect spectra of light over one or more of the wavelength ranges of 200 nm-1000 nm. In yet other embodiments, detectors of interest are configured to measure light emitted by a sample in the flow stream at one or more specific wavelengths. For example, modules may include one or more detectors configured to measure light at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof. In certain embodiments, one or more detectors may be configured to be paired with specific fluorophores, such as those used with the sample in a fluorescence assay.

Flow cytometers may include any suitable mechanism(s) for providing sheath fluid and sample fluid to the sample fluid input coupler and sheath fluid input coupler. For example, the sample fluid input coupler may be fluidically connected to a sample fluid line (e.g., tubing) fluidically connected to a sample fluid reservoir. Similarly, the sheath fluid input coupler may be fluidically connected to a sheath fluid line fluidically connected to a sheath fluid reservoir. Similarly, flow cytometers may include any suitable mechanism(s) for managing waste from the flow stream. The fluidic output coupler may be fluidically connected to a waste line fluidically connected to a waste reservoir. Fluid management systems that may be adapted for use in the subject flow cytometers are provided in U.S. Patent Application Publication No. 2022/0341838, the disclosure of which is incorporated by reference herein in its entirety.

Suitable flow cytometry systems may include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49 (pt 1): 17-28; Linden, et. al., Semin Throm Hemost. 2004 October; 30 (5): 502-11; Alison, et al. J Pathol, 2010 December; 222 (4): 335-344; and Herbig, et al. (2007) Crit Rev Ther Drug Carrier Syst. 24 (3): 203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter, BD Biosciences FACSDiscover™ cell sorter, or the like.

In some embodiments, the subject systems are flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

In some embodiments, the flow cytometer is configured as an imaging flow cytometer. For example, in certain instances, the subject systems are flow cytometry systems configured for imaging particles in a flow stream by fluorescence imaging using radiofrequency tagged emission (FIRE), such as those described in Diebold, et al. Nature Photonics Vol. 7 (10); 806-810 (2013) as well as described in U.S. Pat. Nos. 9,423,353; 9,784,661; 9,983,132; 10,006,852; 10,036,699; 10,078,045; 10,222,316; 10,288,546; 10,324,019; 10,408,758; 10,451,538; 10,620,111; 10,684,211; 10,845,295; 10,935,482; 10,935,485; 11,105,728; 11,280,718; 11,327,016; 11,366,052; 11,371,937; 11,692,926; 11,630,053; 11,774,343; 11,940,369; and 11,946,851; the disclosures of which are herein incorporated by reference. In some embodiments where the flow cytometer is a particle sorter, the particle sorter is an image enabled particle sorter. Image enabled particle sorters are described in U.S. Pat. Nos. 10,324,019; 10,620,111; 11,105,728; and 11,774,343; as well as U.S. patent application Ser. Nos. 18/537,103; 18/657,618; 18,657,623 and 18/657,633; the disclosures of which are herein incorporated by reference in their entirety.

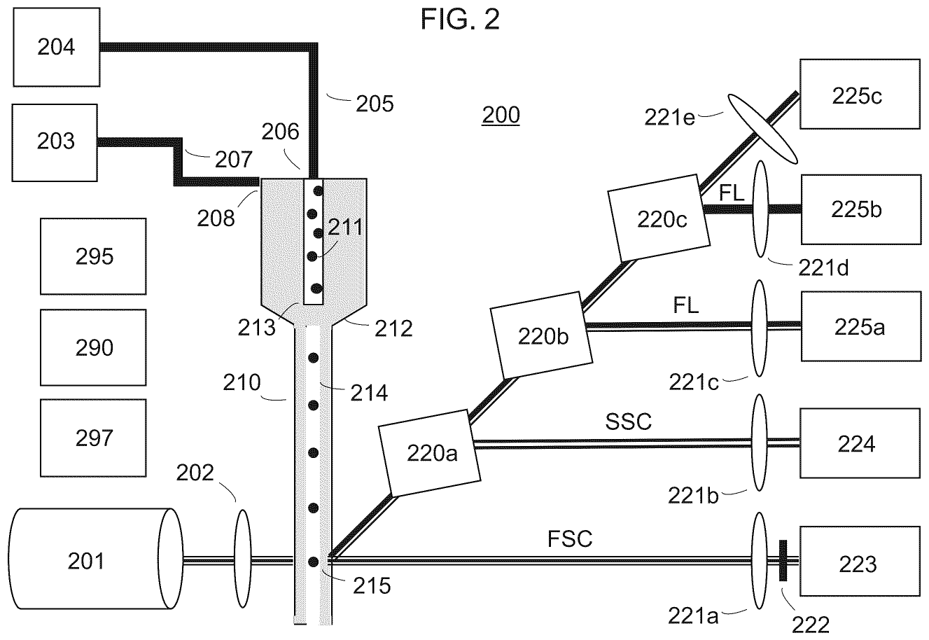

FIG. 2 shows a system 200 for flow cytometry in accordance with an illustrative embodiment of the present disclosure. System 200 includes a laser 201 configured to irradiate particles 211 in flow stream 214 at interrogation point 215 within flow cell 210. While the example of FIG. 2 shows a single laser, it is understood that multiple lasers could also be used. The laser beam from laser 201 is directed to focusing lens 202 which focuses the beam onto the portion of a fluid stream where particles 211 of a sample are located, within the flow cell 210. The flow cell 210 is part of a fluidics system which directs particles, typically one at a time, in a stream to the focused laser beam for interrogation. Alternatively, where the flow cytometer is a stream-in-air cytometer, a nozzle top may be employed.

As shown in FIG. 2, flow cell 210 is fluidically connected to sheath fluid reservoir 203 comprising a sheath fluid and sample fluid reservoir 204 comprising a sample fluid. Sheath fluid from sheath fluid reservoir 203 is provided to at least one sheath fluid injection port 208 via conduit (i.e., sheath fluid line) 207. In addition, sample fluid containing particles 211 from sample fluid reservoir 204 is provided to sample injection port 206 via conduit (i.e., sample fluid line) 205. Sample injection port 206 is fluidically connected to sample injector 213 (e.g., sample injection needle) which is configured to introduce particles 211 into the interior of flow cell 210. Particles 211 are hydrodynamically focused via sheath fluid entering from sheath fluid injection port 208 such that flow stream 214 forms downstream of tapered portion 212 of flow cell 210. Particles emitting at the distal end of flow cell 210 may be disposed of and/or collected via any suitable protocol. For example, depending on the type of flow cytometry being performed, particles may be collected at the distal end of flow cell 210, e.g., via a waste line. Alternatively, particles may be sorted.

The light from the laser beam(s) interacts with the particles 211 in the sample by diffraction, refraction, reflection, scattering, and absorption with re-emission at various different wavelengths depending on the characteristics of the particle such as its size, internal structure, and the presence of one or more fluorescent molecules attached to or naturally present on or in the particle. The fluorescence emissions as well as the diffracted light, refracted light, reflected light, and scattered light may be routed to one or more detectors. In particular, forward scattered light (FSC) is routed to forward-scattered light detector 223. The forward-scattered light detector 223 is positioned slightly off axis from the direct beam through the flow cell 210 and is configured to detect diffracted light, the excitation light that travels through or around the particle in mostly a forward direction. The intensity of the light detected by the forward-scattered light detector 223 is dependent on the overall size of the particle. The forward-scatter detector can include, e.g., a photodiode. Positioned between forward-scattered light detector 223 are optical filter 221a and scatter bar 222. Optical filter 221a may be configured to filter out at least one wavelength of non-FSC light, while scatter bar 222 may be configured to prevent the incident beam from laser 201 (i.e., non-scattered light) from being detected by forward-scattered light detector 223.

In addition, side-scattered light (SSC) is detected by side-scattered light detector 224. In other words, side-scattered light detector 224 is configured to detect refracted and reflected light from the surfaces and internal structures of the particles 211 that tend to increase with increasing particle complexity of structure. In the example of FIG. 2, flow cytometer 200 includes dichroic mirror 220a configured to reflect SSC light to side-scattered light detector 224 while passing non-SSC (e.g., fluorescent) light. Optical filter 221b is configured to prevent at least one wavelength of non-SSC light from being detected by side-scattered light detector 224. Also shown are fluorescent light detectors 225a-225c which are each configured to detect different wavelengths of fluorescent light. For example, dichroic mirror 220b may be configured to reflect fluorescent light (FL) corresponding to a first wavelength (or range of wavelengths) to fluorescent light detector 225a while passing other wavelengths of light. Optical filter 221c may be configured to prevent at least one wavelength of light that does not correspond to the first wavelength (or range of wavelengths) from being detected by fluorescent light detector 225a. Similarly, dichroic mirror 220c is configured to reflect FL light corresponding to a second wavelength (or range of wavelengths) to fluorescent light detector 225b while passing a third wavelength of light (or range of wavelengths) for detection by fluorescent light detector 225c. Optical filter 221d is configured to prevent at least one wavelength of light that does not correspond to the second wavelength (or range of wavelengths) from being detected by fluorescent light detector 225b. In addition, Optical filter 221e is configured to prevent at least one wavelength of light that does not correspond to the third wavelength (or range of wavelengths) from being detected by fluorescent light detector 225c.

One of skill in the art will recognize that a flow cytometer in accordance with an embodiment of the present disclosure is not limited to the flow cytometer depicted in FIG. 2, but can include any flow cytometer known in the art. For example, a flow cytometer may have any number of lasers, beam splitters, filters, and detectors at various wavelengths and in various different configurations. For example, while the embodiment of FIG. 2 shows 3 fluorescent light detectors for illustrative purposes, it is understood that any suitable number of fluorescent light detectors may be employed.

In operation, cytometer operation is controlled by a controller/processor 290, and the measurement data from the detectors can be stored in the memory 295 and processed by the controller/processor 290. Although not shown explicitly, the controller/processor 290 is coupled to the detectors to receive the output signals therefrom, and may also be coupled to electrical and electromechanical components of the flow cytometer to control the laser 201, fluid flow parameters, and the like. Input/output (I/O) capabilities 297 may be provided also in the system. The memory 295, controller/processor 290, and I/O 297 may be entirely provided as an integral part of the flow cytometer. In such an embodiment, a display may also form part of the I/O capabilities 297 for presenting experimental data to users of the cytometer 200. Alternatively, some or all of the memory 295 and controller/processor 290 and I/O capabilities may be part of one or more external devices such as a general purpose computer. In some embodiments, some or all of the memory 295 and controller/processor 290 can be in wireless or wired communication with the cytometer 210. The controller/processor 290 in conjunction with the memory 295 and the I/O 297 can be configured to perform various functions related to the preparation and analysis of a flow cytometer experiment.

Different fluorescent molecules in a fluorochrome panel used for a flow cytometer experiment will emit light in their own characteristic wavelength bands. The particular fluorescent labels used for an experiment and their associated fluorescent emission bands may be selected to generally coincide with the filter windows of the detectors. The I/O 297 can be configured to receive data regarding a flow cytometer experiment having a panel of fluorescent labels and a plurality of cell populations having a plurality of markers, each cell population having a subset of the plurality of markers. The I/O 297 can also be configured to receive biological data assigning one or more markers to one or more cell populations, marker density data, emission spectrum data, data assigning labels to one or more markers, and cytometer configuration data. Flow cytometer experiment data, such as label spectral characteristics and flow cytometer configuration data can also be stored in the memory 295. The controller/processor 290 can be configured to evaluate one or more assignments of labels to markers.

In some embodiments, the subject systems are particle sorting systems that are configured to sort particles with an enclosed particle sorting module, such as those described in U.S. Patent Publication No. 2017/0299493, filed on Mar. 28, 2017, the disclosure of which is incorporated herein by reference. In certain embodiments, particles (e.g., cells) of the sample are sorted using a sort decision module having a plurality of sort decision units, such as those described in U.S. Patent Publication No. 2020/0256781, filed on Dec. 23, 2019, the disclosure of which is incorporated herein by reference. In some embodiments, systems for sorting components of a sample include a particle sorting module having deflection plates, such as described in U.S. Patent Publication No. 2017/0299493, filed on Mar. 28, 2017, the disclosure of which is incorporated herein by reference.

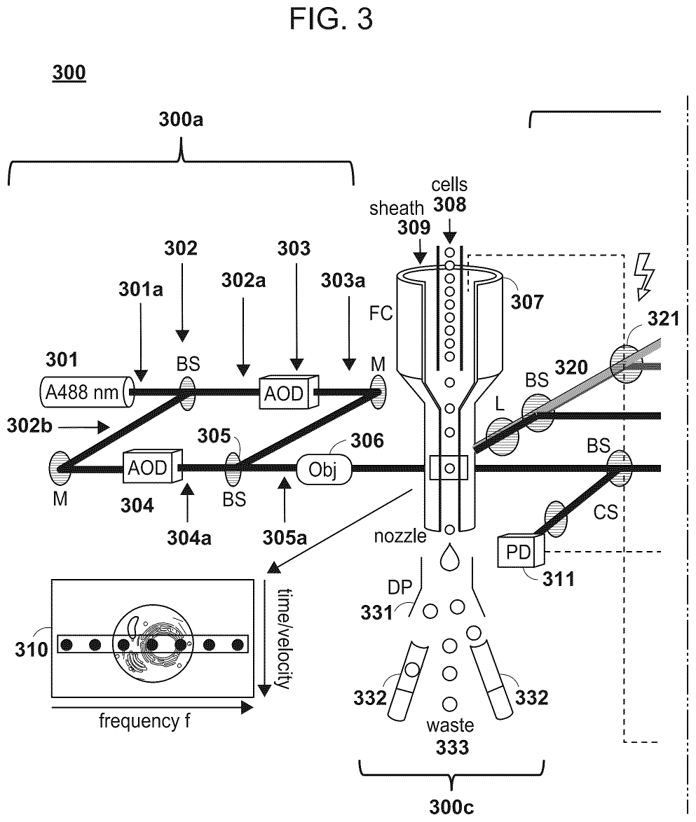

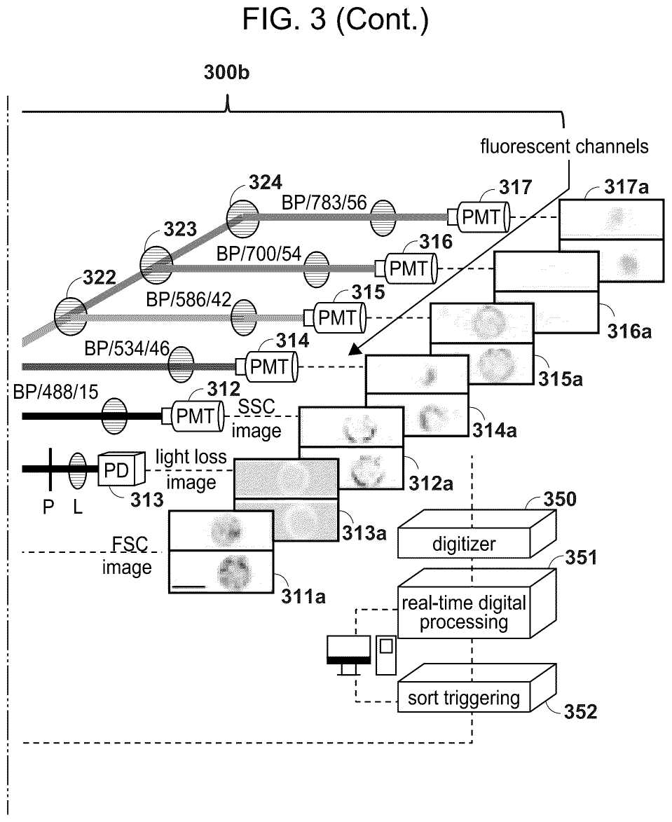

In certain embodiments, systems are a fluorescence imaging using radiofrequency tagged emission image-enabled particle sorter, such as depicted in FIG. 3. Particle sorter 300 includes a light irradiation component 300a which includes light source 301 (e.g., 488 nm laser) which generates output beam of light 301a that is split with beamsplitter 302 into beams 302a and 302b. Light beam 302a is propagated through acousto-optic device (e.g., an acousto-optic deflector, AOD) 303 to generate an output beam 303a having one or more angularly deflected beams of light. In some instances, output beam 303a generated from acousto-optic device 303 includes a local oscillator beam and a plurality of radiofrequency comb beams. Light beam 302b is propagated through acousto-optic device (e.g., an acousto-optic deflector, AOD) 304 to generate an output beam 304a having one or more angularly deflected beams of light. In some instances, output beam 304a generated from acousto-optic device 304 includes a local oscillator beam and a plurality of radiofrequency comb beams. Output beams 303a and 304a generated from acousto-optic devices 303 and 304, respectively are combined with beamsplitter 305 to generate output beam 305a which is conveyed through an optical component 306 (e.g., an objective lens) to irradiate particles in flow cell 307. In certain embodiments, acousto-optic device 303 (AOD) splits a single laser beam into an array of beamlets, each having different optical frequency and angle. Second AOD 304 tunes the optical frequency of a reference beam, which is then overlapped with the array of beamlets at beam combiner 305. In certain embodiments, the light irradiation system having a light source and acousto-optic device can also include those described in Schraivogel, et al. (“High-speed fluorescence image-enabled cell sorting” Science (2022), 375 (6578): 315-320) and United States Patent Publication No. 2021/0404943, the disclosure of which is herein incorporated by reference.

Output beam 305a irradiates sample particles 308 propagating through flow cell 307 (e.g., with sheath fluid 309) at irradiation region 310. As shown in irradiation region 310, a plurality of beams (e.g., angularly deflected radiofrequency shifted beams of light depicted as dots across irradiation region 310) overlaps with a reference local oscillator beam (depicted as the shaded line across irradiation region 310). Due to their differing optical frequencies, the overlapping beams exhibit a beating behavior, which causes each beamlet to carry a sinusoidal modulation at a distinct frequency f₁₋ₙ.

Light from the irradiated sample is conveyed to light detection system 300b that includes a plurality of photodetectors. Light detection system 300b includes forward scattered light photodetector 311 for generating forward scatter images 311a and a side scattered light photodetector 312 for generating side scatter images 312a. Light detection system 300b also includes brightfield photodetector 313 for generating light loss images 313a. In some embodiments, forward scatter detector 311 and side scatter detector 312 are photodiodes (e.g., avalanche photodiodes, APDs). In some instances, brightfield photodetector 313 is a photomultiplier tube (PMT). Fluorescence from the irradiated sample is also detected with fluorescence photodetectors 314-317. In some instances, photodetectors 314-317 are photomultiplier tubes. Light from the irradiated sample is directed to the side scatter detection channel 312 and fluorescence detection channels 314-317 through beamsplitter 320. Light detection system 300b includes bandpass optical components 321, 322, 323 and 324 (e.g., dichroic mirrors) for propagating predetermined wavelength of light to photodetectors 314-317. In some instances, optical component 321 is a 534 nm/40 nm bandpass. In some instances, optical component 322 is a 586 nm/42 nm bandpass. In some instances, optical component 323 is a 700 nm/54 nm bandpass. In some instances, optical component 324 is a 783 nm/56 nm bandpass. The first number represents the center of a spectral band. The second number provides a range of the spectral band. Thus, a 510/20 filter extends 10 nm on each side of the center of the spectral band, or from 500 nm to 520 nm.

Data signals generated in response to light detected in scattered light detection channels 311 and 312, brightfield light detection channel 313 and fluorescence detection channels 314-317 are processed by real-time digital processing with processors 350 and 351. Images 311a-317a can be generated in each light detection channel based on the data signals generated in processors 350 and 351. Image-enabled sorting is performed in response to a sort signal generated in sort trigger 352. Sorting component 300c includes deflection plates 331 for deflecting particles into sample containers 332 or to waste stream 333. In some instances, sort component 300c is configured to sort particles with an enclosed particle sorting module, such as those described in U.S. Patent Publication No. 2017/0299493, filed on Mar. 28, 2017, the disclosure of which is incorporated herein by reference. In certain embodiments, sorting component 300c includes a sort decision module having a plurality of sort decision units, such as those described in U.S. Patent Publication No. 2020/0256781, the disclosure of which is incorporated herein by reference.

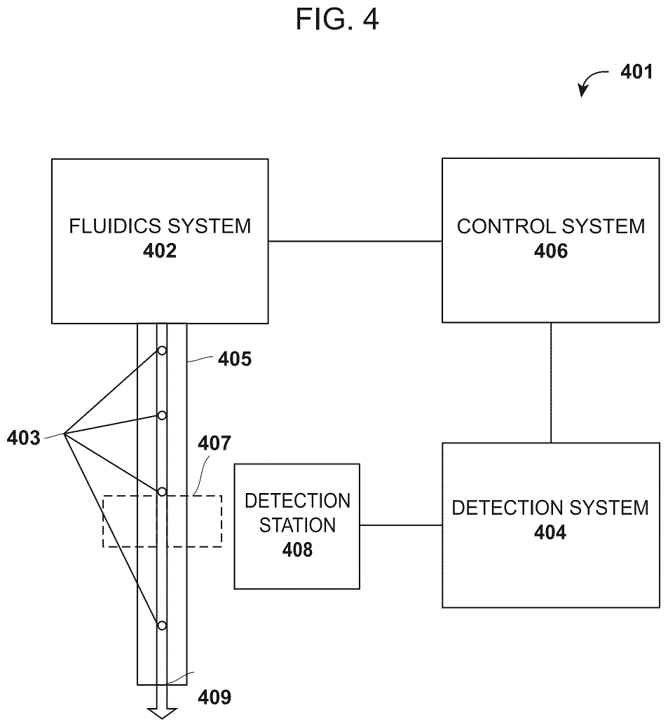

In some embodiments, systems are particle analyzers where the particle analysis system 401 (FIG. 4) can be used to analyze and characterize particles, with or without physically sorting the particles into collection vessels. FIG. 4 shows a functional block diagram of a particle analysis system for computational based sample analysis and particle characterization. In some embodiments, the particle analysis system 401 is a flow system. The particle analysis system 401 includes a fluidics system 402. The fluidics system 402 can include or be coupled with a sample tube 405 and a moving fluid column within the sample tube in which particles 403 (e.g. cells) of a sample move along a common sample path 409.

The particle analysis system 401 includes a detection system 404 configured to collect a signal from each particle as it passes one or more detection stations along the common sample path. A detection station 408 generally refers to a monitored area 407 of the common sample path. Detection can, in some implementations, include detecting light or one or more other properties of the particles 403 as they pass through a monitored area 407. In FIG. 4, one detection station 408 with one monitored area 407 is shown. Some implementations of the particle analysis system 401 can include multiple detection stations. Furthermore, some detection stations can monitor more than one area.

Each signal is assigned a signal value to form a data point for each particle. As described above, this data can be referred to as event data. The data point can be a multidimensional data point including values for respective properties measured for a particle. The detection system 404 is configured to collect a succession of such data points in a first-time interval.

The particle analysis system 401 can also include a control system 406. The control system 406 can include one or more processors, an amplitude control circuit and/or a frequency control circuit. The control system shown can be operationally associated with the fluidics system 402. The control system can be configured to generate a calculated signal frequency for at least a portion of the first-time interval based on a Poisson distribution and the number of data points collected by the detection system 404 during the first time interval. The control system 406 can be further configured to generate an experimental signal frequency based on the number of data points in the portion of the first time interval. The control system 406 can additionally compare the experimental signal frequency with that of a calculated signal frequency or a predetermined signal frequency.

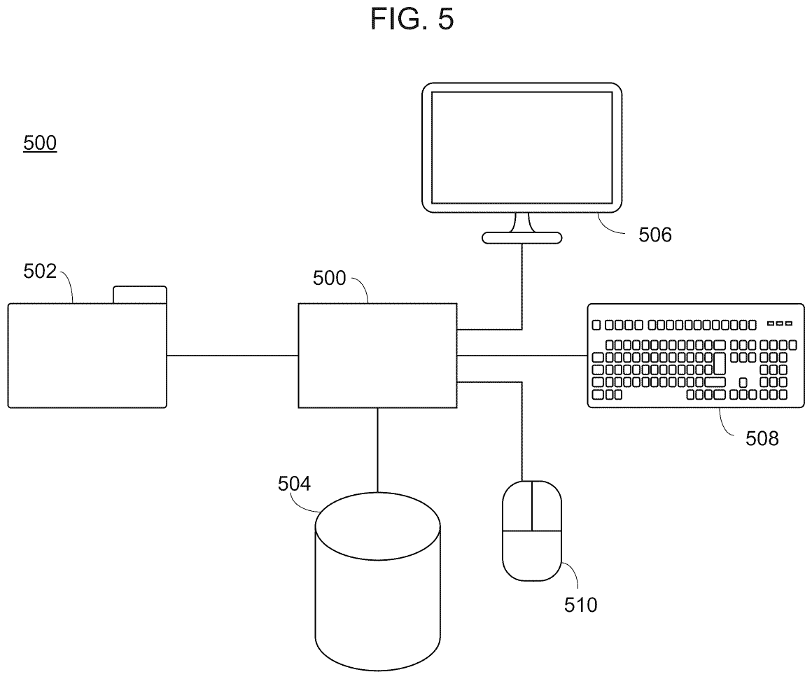

FIG. 5 shows a functional block diagram for one example of a particle analyzer control system, such as an analytics controller (i.e., processor) 500, for analyzing and displaying biological events. An analytics controller 500 can be configured to implement a variety of processes for controlling graphic display of biological events.

A particle analyzer or sorting system 502 can be configured to acquire biological event data. For example, a flow cytometer can generate flow cytometric event data. The particle analyzer 502 can be configured to provide biological event data to the analytics controller 500. A data communication channel can be included between the particle analyzer or sorting system 502 and the analytics controller 500. The biological event data can be provided to the analytics controller 500 via the data communication channel.

The analytics controller 500 can be configured to receive biological event data from the particle analyzer or sorting system 502. The biological event data received from the particle analyzer or sorting system 502 can include flow cytometric event data. The analytics controller 500 can be configured to provide a graphical display including a first plot of biological event data to a display device 506. The analytics controller 500 can be further configured to render a region of interest as a gate around a population of biological event data shown by the display device 506, overlaid upon the first plot, for example. In some embodiments, the gate can be a logical combination of one or more graphical regions of interest drawn upon a single parameter histogram or bivariate plot. In some embodiments, the display can be used to display particle parameters or saturated detector data.

The analytics controller 500 can be further configured to display the biological event data on the display device 506 within the gate differently from other events in the biological event data outside of the gate. For example, the analytics controller 500 can be configured to render the color of biological event data contained within the gate to be distinct from the color of biological event data outside of the gate. The display device 506 can be implemented as a monitor, a tablet computer, a smartphone, or other electronic device configured to present graphical interfaces.

The analytics controller 500 can be configured to receive a gate selection signal identifying the gate from a first input device. For example, the first input device can be implemented as a mouse 510. The mouse 510 can initiate a gate selection signal to the analytics controller 500 identifying the gate to be displayed on or manipulated via the display device 506 (e.g., by clicking on or in the desired gate when the cursor is positioned there). In some implementations, the first device can be implemented as the keyboard 508 or other means for providing an input signal to the analytics controller 500 such as a touchscreen, a stylus, an optical detector, or a voice recognition system. Some input devices can include multiple inputting functions. In such implementations, the inputting functions can each be considered an input device. For example, as shown in FIG. 5, the mouse 510 can include a right mouse button and a left mouse button, each of which can generate a triggering event.

The triggering event can cause the analytics controller 500 to alter the manner in which the data is displayed, which portions of the data is actually displayed on the display device 506, and/or provide input to further processing such as selection of a population of interest for particle sorting.

In some embodiments, the analytics controller 500 can be configured to detect when gate selection is initiated by the mouse 510. The analytics controller 500 can be further configured to automatically modify plot visualization to facilitate the gating process. The modification can be based on the specific distribution of biological event data received by the analytics controller 500.

The analytics controller 500 can be connected to a storage device 504. The storage device 504 can be configured to receive and store biological event data from the analytics controller 500. The storage device 504 can also be configured to receive and store flow cytometric event data from the analytics controller 500. The storage device 504 can be further configured to allow retrieval of biological event data, such as flow cytometric event data, by the analytics controller 500.

A display device 506 can be configured to receive display data from the analytics controller 500. The display data can comprise plots of biological event data and gates outlining sections of the plots. The display device 506 can be further configured to alter the information presented according to input received from the analytics controller 500 in conjunction with input from the particle analyzer 502, the storage device 504, the keyboard 508, and/or the mouse 510.

In some implementations, the analytics controller 500 can generate a user interface to receive example events for sorting. For example, the user interface can include a control for receiving example events or example images. The example events or images or an example gate can be provided prior to collection of event data for a sample, or based on an initial set of events for a portion of the sample.

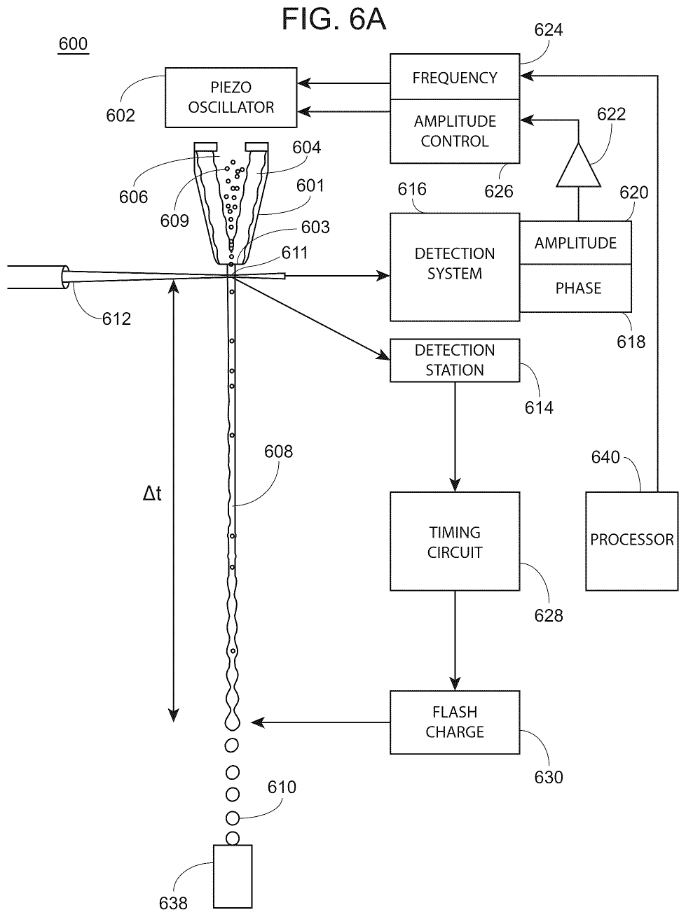

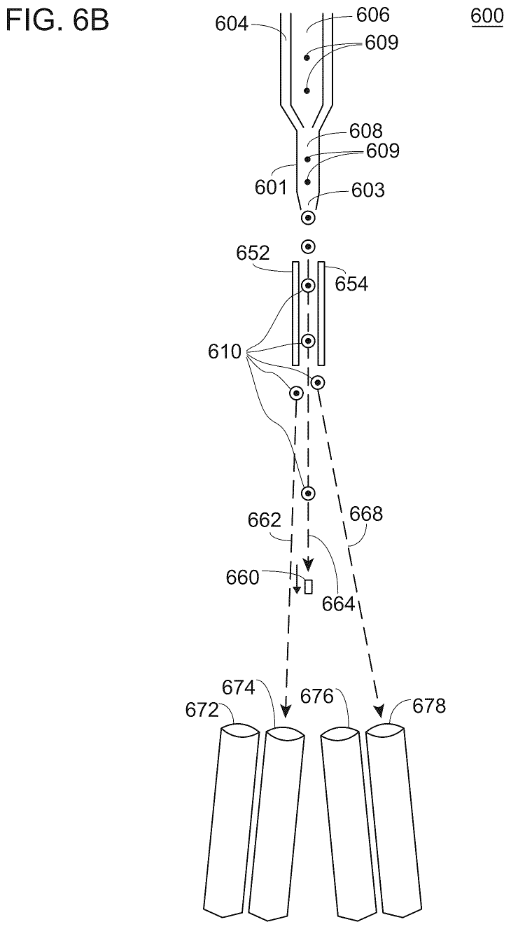

FIG. 6A is a schematic drawing of a particle sorter system 600 (e.g., the particle analyzer or sorting system 502) in accordance with one embodiment presented herein. In some embodiments, the particle sorter system 600 is a cell sorter system. As shown in FIG. 6A, a drop formation transducer 602 (e.g., piezo-oscillator) is coupled to a fluid conduit 601, which can be coupled to, can include, or can be, a nozzle 603. Within the fluid conduit 601, sheath fluid 604 hydrodynamically focuses a sample fluid 606 comprising particles 609 into a moving fluid column 608 (e.g., a stream). Within the moving fluid column 608, particles 609 (e.g., cells) are lined up in single file to cross a monitored area 611 (e.g., where laser-stream intersect), irradiated by an irradiation source 612 (e.g., a laser). Vibration of the drop formation transducer 602 causes moving fluid column 608 to break into a plurality of drops 610, some of which contain particles 609.

In operation, a detection station 614 (e.g., an event detector) identifies when a particle of interest (or cell of interest) crosses the monitored area 611. Detection station 614 feeds into a timing circuit 628, which in turn feeds into a flash charge circuit 630. At a drop break off point, informed by a timed drop delay (Δt), a flash charge can be applied to the moving fluid column 608 such that a drop of interest carries a charge. The drop of interest can include one or more particles or cells to be sorted. The charged drop can then be sorted by activating deflection plates (not shown) to deflect the drop into a vessel such as a collection tube or a multi-well or microwell sample plate where a well or microwell can be associated with drops of particular interest. As shown in FIG. 6A, the drops can be collected in a drain receptacle 638.

A detection system 616 (e.g., a drop boundary detector) serves to automatically determine the phase of a drop drive signal when a particle of interest passes the monitored area 611. An exemplary drop boundary detector is described in U.S. Pat. No. 7,679,039, which is incorporated herein by reference in its entirety. The detection system 616 allows the instrument to accurately calculate the place of each detected particle in a drop. The detection system 616 can feed into an amplitude signal 620 and/or phase 618 signal, which in turn feeds (via amplifier 622) into an amplitude control circuit 626 and/or frequency control circuit 624. The amplitude control circuit 626 and/or frequency control circuit 624, in turn, controls the drop formation transducer 602. The amplitude control circuit 626 and/or frequency control circuit 624 can be included in a control system.

In some implementations, sort electronics (e.g., the detection system 616, the detection station 614 and a processor 640) can be coupled with a memory configured to store the detected events and a sort decision based thereon. The sort decision can be included in the event data for a particle. In some implementations, the detection system 616 and the detection station 614 can be implemented as a single detection unit or communicatively coupled such that an event measurement can be collected by one of the detection system 616 or the detection station 614 and provided to the non-collecting element.

FIG. 6B is a schematic drawing of a particle sorter system, in accordance with one embodiment presented herein. The particle sorter system 600 shown in FIG. 6B, includes deflection plates 652 and 654. A charge can be applied via a stream-charging wire in a barb. This creates a stream of droplets 610 containing particles 610 for analysis. The particles can be illuminated with one or more light sources (e.g., lasers) to generate light scatter and fluorescence information. The information for a particle is analyzed such as by sorting electronics or other detection system (not shown in FIG. 6B). The deflection plates 652 and 654 can be independently controlled to attract or repel the charged droplet to guide the droplet toward a destination collection receptacle (e.g., one of 672, 674, 676, or 678). As shown in FIG. 6B, the deflection plates 652 and 654 can be controlled to direct a particle along a first path 662 toward the receptacle 674 or along a second path 668 toward the receptacle 678. If the particle is not of interest (e.g., does not exhibit scatter or illumination information within a specified sort range), deflection plates may allow the particle to continue along a flow path 664. Such uncharged droplets may pass into a waste receptacle such as via aspirator 670.

The sorting electronics can be included to initiate collection of measurements, receive fluorescence signals for particles, and determine how to adjust the deflection plates to cause sorting of the particles. Example implementations of the embodiment shown in FIG. 6B include the BD FACSAria™ line of flow cytometers commercially provided by Becton, Dickinson and Company (Franklin Lakes, NJ).

### Computer-Controlled Systems

Aspects of the disclosure additionally include computer-controlled systems, where the systems include one or more computers for complete automation or partial automation. In some embodiments, systems include a computer having a non-transitory computer readable storage medium with a computer program stored thereon, where the computer program when loaded on the computer includes instructions for performing methods of the disclosure. For example, the computer may be configured to identify measurement uncertainty corresponding to individual particles in the sample, or identify measurement uncertainty for individual parameters of detected light for particles in the sample or may be configured for generating a quality score for each particle based on the measurement uncertainty for each particle.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor, or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, Python, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. In some embodiments, the processor includes analog electronics which provide feedback control, such as for example negative feedback control.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, or a diskette drive. Such types of memory storage devices typically read from, and/or write to, a program storage medium (not shown) such as a compact disk. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid-state storage devices (including magnetic or optical disks or tape or RAM, or any other suitable device, either fixed or portable). The processor may include a general-purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the disclosure also include programming, e.g., in the form of computer program products, algorithms for use in practicing the methods as described above. Programming according to the present disclosure can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, Wi-Fi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, a USB-C port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or Wi-Fi connection to the internet at a Wi-Fi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a workstation, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows^{□} NT^{□}, Windows XP^{□}, Windows 7^{□}, Windows 8^{□}, Windows 10^{□}, iOS^{□}, macOS^{□}, Linux^{□}, Ubuntu^{□}, Fedora^{□}, OS/400^{□}, i5/OS^{□}, IBM i^{□}, Android™, SGI IRIX^{□}, Oracle Solaris^{□} and others.

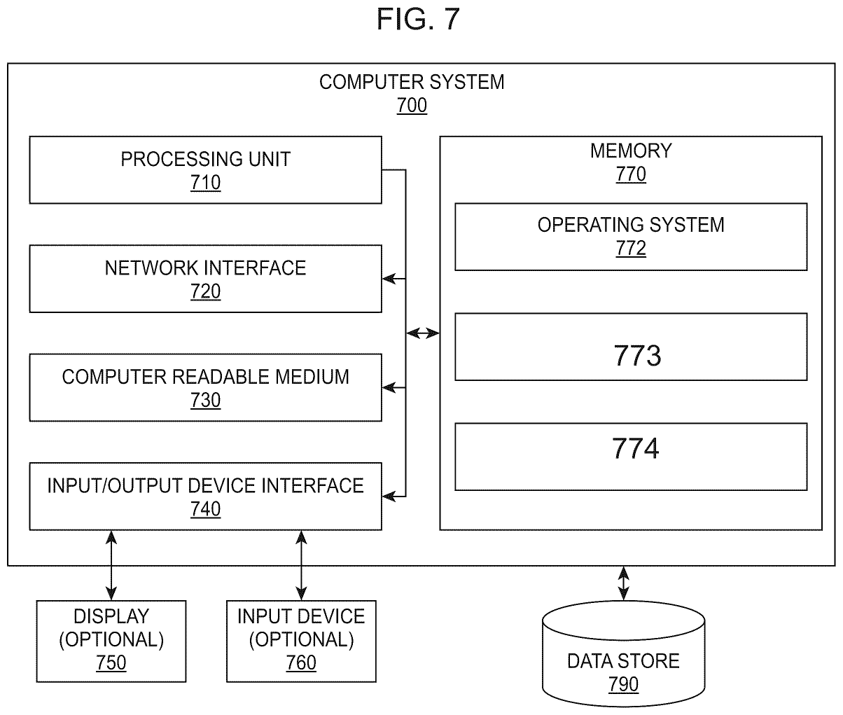

FIG. 7 depicts a general architecture of an example computing device 700 according to certain embodiments. The general architecture of the computing device 700 depicted in FIG. 7 includes an arrangement of computer hardware and software components. It is not necessary, however, that all of these generally conventional elements be shown in order to provide an enabling disclosure. As illustrated, the computing device 700 includes a processing unit 710, a network interface 720, a computer readable medium drive 730, an input/output device interface 740, a display 750, and an input device 760, all of which may communicate with one another by way of a communication bus. The network interface 720 may provide connectivity to one or more networks or computing systems. The processing unit 710 may thus receive information and instructions from other computing systems or services via a network. The processing unit 710 may also communicate to and from memory 770 and further provide output information for an optional display 750 via the input/output device interface 740. For example, an analysis software (e.g., data analysis software or program such as FlowJo®) stored as executable instructions in the non-transitory memory of the analysis system can display the flow cytometry event data to a user. The input/output device interface 740 may also accept input from the optional input device 760, such as a keyboard, mouse, digital pen, microphone, touch screen, gesture recognition system, voice recognition system, gamepad, accelerometer, gyroscope, or other input device.

The memory 770 may contain computer program instructions (grouped as modules or components in some embodiments) that the processing unit 710 executes in order to implement one or more embodiments. The memory 770 generally includes RAM, ROM and/or other persistent, auxiliary or non-transitory computer-readable media. The memory 770 may store an operating system 772 that provides computer program instructions for use by the processing unit 710 in the general administration and operation of the computing device 700. Data may be stored in data storage device 790. The memory 770 may further include computer program instructions and other information for implementing aspects of the present disclosure, such as module for identifying measurement uncertainty associated with the detected light 773 or module for recording measurement uncertainty associated with the detected light 774.

### Integrated Circuit Devices

Aspects of the present disclosure also include integrated circuit devices programmed for identifying measurement uncertainty associated with light detected from a sample as described in the methods detailed above. In some embodiments, integrated circuit devices of interest include a field programmable gate array (FPGA). In other embodiments, integrated circuit devices include an application specific integrated circuit (ASIC). In yet other embodiments, integrated circuit devices include a complex programmable logic device (CPLD). In embodiments, integrated circuit devices are configured for practicing practice the subject methods, as described herein.

### Kits

Aspects of the present disclosure further include kits, where kits include one or more of the integrated circuits described herein or the systems described herein or the non-transitory computer readable recording media described herein. In some embodiments, kits may further include programming for the subject systems, such as in the form of a computer readable medium (e.g., flash drive, USB storage, compact disk, DVD, Blu-ray disk, etc.) or instructions for downloading the programming from an internet web protocol or cloud server.

In addition to the above components, the subject kits may further include (in some embodiments) instructions. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, and the like. Yet another form of these instructions is a computer readable medium, e.g., diskette, compact disk (CD), portable flash drive, and the like, on which the information has been recorded. Yet another form of these instructions that may be present is a website address which may be used via the internet to access the information at a removed site.

### Utility

Embodiments of the disclosure find use in a variety of applications where it is desirable to analyze and sort particle components in a sample in a fluid medium, such as a biological sample. In some embodiments, the systems and methods described herein find use in flow cytometry characterization of biological samples labelled with fluorescent tags. In other embodiments, the systems and methods find use in spectroscopy of emitted light. In addition, the subject systems and methods find use in increasing the obtainable signal from light collected from a sample (e.g., in a flow stream). In certain instances, the present disclosure finds use in enhancing measurement of light collected from a sample that is irradiated in a flow stream in a flow cytometer. Embodiments of the present disclosure find use where it is desirable to provide a flow cytometer with improved cell sorting accuracy, enhanced particle collection, particle charging efficiency, more accurate particle charging and enhanced particle deflection during cell sorting.

Embodiments of the disclosure find use in applications where cells prepared from a biological sample may be desired for research, laboratory testing or for use in therapy. In some embodiments, the subject methods and devices may facilitate obtaining and/or analyzing individual cells prepared from a target fluidic or tissue biological sample. For example, the subject methods and systems facilitate obtaining cells from fluidic or tissue samples to be used as a research or diagnostic specimen for diseases such as cancer. Likewise, the subject methods and systems may facilitate obtaining cells from fluidic or tissue samples to be used in therapy.

Although the foregoing disclosure has been described in some detail by way of illustration and example for purposes of clarity of understanding, it is readily apparent to those of ordinary skill in the art in light of the teachings of this disclosure that some changes and modifications may be made thereto without departing from the spirit or scope of the appended claims.

Accordingly, the preceding merely illustrates the principles of the disclosure. It will be appreciated that those skilled in the art will be able to devise various arrangements which, although not explicitly described or shown herein, embody the principles of the disclosure and are included within its spirit and scope. Furthermore, all examples and conditional language recited herein are principally intended to aid the reader in understanding the principles of the disclosure and the concepts contributed by the inventors to furthering the art, and are to be construed as being without limitation to such specifically recited examples and conditions. Moreover, all statements herein reciting principles, aspects, and embodiments of the disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present disclosure, therefore, is not intended to be limited to the exemplary embodiments shown and described herein. Rather, the scope and spirit of present disclosure is embodied by the appended claims. In the claims, 35 U.S.C. § 112 (f) or 35 U.S.C. § 112 (6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112 (6) is not invoked.

1-259. (canceled)

260. A method comprising:
introducing a sample into a flow cytometer;
flowing the introduced sample in a flow stream;
irradiating the sample in the flow stream with a light source;
detecting light from particles in the sample flowing in the flow stream; and
identifying measurement uncertainty associated with the detected light.

261. The method of claim 260, wherein the measurement uncertainty relates to a binary classification, wherein the binary classification optionally comprises one or more of gating or population membership classifications.

262. The method of claim 260, further comprising:
calculating a quality score based on the measurement uncertainty,
wherein the quality score reflects a likelihood of membership in a gate.

263. The method of claim 262, wherein the likelihood of membership in the gate is calculated for each gate in a gate hierarchy, and/or wherein the likelihood of membership in the gate is calculated taking into account each hierarchical parent gate of the gate.

264. The method of claim 260, wherein identifying measurement uncertainty associated with the detected light comprises one or more of:
estimating measurement uncertainty associated with the detected light,
measuring measurement uncertainty associated with the detected light, or
predicting measurement uncertainty associated with the detected light.

265. The method of claim 260, further comprising:
classifying particles based on detected light; and
calculating a confidence interval for classification of particles based at least in part on the measurement uncertainty.

266. The method of claim 260, further comprising:
using the measurement uncertainty for probabilistic analysis of particle classification or sorting, wherein the probabilistic classification optionally comprises applying a fuzzy logic technique.

267. The method of claim 260, further comprising:
identifying a gate membership confidence score for each event and each gate, wherein the gate membership confidence score comprises a likelihood that a true biological expression level for a given event falls within a given gate.

268. The method of claim 260, wherein the method is a method for calculating gate membership confidence scores.

269. The method of claim 260, further comprising:
using gate membership confidence scores based on measurement uncertainty in particle classification and sorting, wherein particle classification and sorting comprises probabilistic sorting with configurable likelihood thresholds to maximize purity and/or yield.

270. A system comprising:
a light source configured to irradiate a sample comprising a plurality of particles;
a light detection system comprising a plurality of photodetectors; and
a processor comprising memory operably coupled to the processor wherein the memory comprises instructions stored thereon, which when executed by the processor, cause the processor to identify measurement uncertainty associated with light detected from the light detection system.

271. The system of claim 270, wherein the measurement uncertainty relates to a binary classification, wherein the binary classification optionally comprises one or more of gating or population membership classifications.

272. The system of claim 270, wherein the memory comprises instructions stored thereon, which when executed by the processor, cause the processor to calculate a quality score based on the measurement uncertainty, wherein the quality score reflects a likelihood of membership in a gate.

273. The system of claim 272, wherein the likelihood of membership in the gate is calculated for each gate in a gate hierarchy, and/or wherein the likelihood of membership in the gate is calculated taking into account each hierarchical parent gate of the gate.

274. The system of claim 270, wherein identifying measurement uncertainty associated with the detected light comprises one or more of:
estimating measurement uncertainty associated with the detected light,
measuring measurement uncertainty associated with the detected light, or
predicting measurement uncertainty associated with the detected light.

275. The system of claim 270, wherein the memory comprises instructions stored thereon, which when executed by the processor, cause the processor to:
classify particles based on detected light; and
calculate a confidence interval for classification of particles based at least in part on the measurement uncertainty.

276. The system of claim 270, wherein the memory comprises instructions stored thereon, which when executed by the processor, cause the processor to:
use the measurement uncertainty for probabilistic analysis of particle classification or sorting,
wherein the probabilistic classification optionally comprises applying a fuzzy logic technique.

277. The system of claim 270, wherein the memory comprises instructions stored thereon, which when executed by the processor, cause the processor to:
identify a gate membership confidence score for each event and each gate, wherein the gate membership confidence score comprises a likelihood that a true biological expression level for a given event falls within a given gate.

278. The system of claim 270, wherein the system is configured to calculate gate membership confidence scores.

279. The system of claim 270, wherein the memory comprises instructions stored thereon, which when executed by the processor, cause the processor to:
use gate membership confidence scores based on measurement uncertainty in particle classification and sorting, wherein particle classification and sorting comprises probabilistic sorting with configurable likelihood thresholds to maximize purity and/or yield.
